(19) United States
(12) Patent Application Publication
(10) Pub. No.: US 2002/0119429 A1
(43) Pub. Date: Aug. 29, 2002

(54) System for teaching dyslexics to read and spell

(76) Inventor: Susan Barton, San Jose, CA (US)

Correspondence Address: William C. Milks, III, Russo & Hale LLP, 401 Florence Street, Palo Alto, CA, 94301, US

(21) Appl. No.: 09/794,430

(22) Filed: Feb. 27, 2001

(51) Int. Cl. G09B 17/00

(52) U.S. Cl. 434/178

(57) ABSTRACT

A method of teaching dyslexic persons to read and spell, that initially teaches phonemic awareness before letters are introduced. The system includes video instruction for tutors, fully scripted lesson plans, an electronic spell checker, and a word frame to enable viewing words in isolation and also incorporates small tiles as manipulatives. The tiles are square, roughly one inch on a side, and ¼-inch thick. The preferred material is wood. Most of the tiles have one or more black letters printed on their top surface. The particular letter, group of letters, or lack of any letter, and the background color of each tile correspond to its function in the learning process.

### FIELD OF THE INVENTION

The present invention relates to education and, more particularly, to education of persons with learning disabilities. Specifically, one embodiment of the present invention provides a system to educate persons having dyslexia. More specifically, a preferred embodiment of the present invention provides a system to effectively teach dyslexics how to read, as well as spell.

### BACKGROUND OF THE INVENTION

Persons with dyslexia have extreme difficulty reading and spelling. Various approaches for teaching dyslexics to read are based on the research by Orton and Gillingham in the 1930's (Orton, Samuel Torry, Reading, Writing, and Speech Problems in Children, New York: W. W. Norton, 1937). One of the early teaching techniques was published by Gillingham and Stillman (Gillingham, Anna, and Stillman, Bessie, The Gillingham Manual, Cambridge, Mass.: Educators Publishing Service, Inc., 1936).

Results of further research relating to dyslexia have also been published recently by the National Institutes of Health (Lyon, G. R., “Research in Learning Disabilities at the National Institute of Child, Health, and Human Development (NICHD),” Bethesda, Md.: NICHD Technical Document/Human Learning and Behavior Branch, 1994). Techniques for teaching reading to dyslexics continue to evolve. See, for example, Fletcher, J. M., and Lyon, G. R., “Reading: A Research-based Approach,” in What's Gone Wrong in America's Classroom?, ed. W. Evers, Palo Alto, Calif.: Stanford University, Hoover Institution, 1998, pp. 49-90.

The National Institutes of Health research reported that persons with dyslexia have a significant lack of phonemic awareness. Phonemic awareness is the ability to hear each sound within a word. Additionally, dyslexics do not easily integrate what they hear with what they see or write. As a result, learning to read, spell, and write are significant challenges for dyslexic persons.

Traditional classroom techniques for teaching reading (look/say methods, traditional phonics, or the whole language approach) fail on dyslexic students. As a result, dyslexics attempt to read by matching the outline shapes of words, rather than by looking at individual letters. They treat each word as though it were a picture, a single object. So when attempting to read a printed word, a dyslexic compares that “picture” on the page to each of the pictures stored in his or her mind until he or she recalls one that starts with the same letter and has a similar shape and length. Because they are not paying attention to all of the individual letters, they often misread similar-looking words, such as house for horse, sunrise for surprise, and united for untied. Not only is this slow and inefficient, but it relies too heavily on “context clues” such as pictures in a book, the title, and guessing where the story is heading.

Most dyslexics never read above a third-grade level, because long words are too similar in shape for them to distinguish. The main differences among long words are a few letters in the middle, but dyslexics do not notice letters in the middle of a word. So their typical reading strategy fails as words become longer. Moreover, their spelling skills typically lag several years behind their poor reading skills. See, for example, DuBois, Steven, “Settlement Helps Learning-Disabled,” The Associated Press, 2001.

Additionally, while most people increase their vocabularies through reading, dyslexics do not read much if at all, so their vocabularies are typically quite limited. The best known Orton-Gillingham-based technique teaches a relatively efficient reading strategy, which takes dyslexic students to beginning 7^{th} grade reading level, but does not develop spelling skills to a commensurate level.

It would therefore be desirable to effectively teach persons with dyslexia to read and spell proficiently. It would also be desirable to enable dyslexics to develop sufficient proficiency so they have the necessary reading and spelling skills to be on a college entrance track.

### SUMMARY OF THE INVENTION

The present invention provides a method and apparatus for teaching persons with dyslexia to read, spell, and write effectively. One embodiment of the present invention provides a system that promotes development of reading, spelling, and writing skills by dyslexics using a multisensory method that stimulates auditory, visual, and kinesthetic faculties simultaneously to highly integrate use of those senses to help the learning process.

The system in accordance with the present invention also addresses the problem that dyslexics have extreme difficulty reading and spelling due to their significant lack of phonemic awareness. One unique aspect of the method of the present invention is that teaching begins by developing phonemic awareness so that dyslexics are able to change their reading strategy to one of “decoding” an unknown word by sounding it out. Phonemic awareness is taught explicitly, as a separate skill, before letters are introduced.

Printed language must be taught to a dyslexic in a logical, systematic manner, starting with the smallest and most consistent words and gradually working up to complex and less consistent reading and spelling patterns. Another unique aspect of the system of the present invention is the specific order of instruction, which is designed to get dyslexic students reading and spelling long, multi-syllabic words as quickly as possible.

The system provides various levels of learning instruction taught in a specific sequence. The first level teaches phonemic awareness to dyslexic students. The second level teaches simple sound-symbol relationships with only short vowels in three-sound, consonant-vowel-consonant words. The third level focuses on improving sound-symbol relationships using longer words (up to six sounds in a one-syllable word with only one short vowel), and teaches associated spelling rules. In the process, two types of syllables are taught, namely, closed and unit. At the fourth level, students are taught a third syllable type, namely, open, and then are taught two initial syllable-division rules. Next, they are taught about accents and schwas, as well as associated spelling rules Also, an electronic spell checker is introduced at the fourth level so dyslexic students can easily determine which vowel changed to schwa. Students then learn the last two syllable-division rules and spelling rules that apply to words with three or more syllables. The fourth level teaches students one additional type of syllable, namely, a vowel team, and students learn the nine most common vowel teams. Students are also shown how to use the syllable-division rules with vowel teams. The method of the present invention also comprises a fifth level that teaches the meaning of the 15 most common suffixes and associated spelling rules, followed by the 12 most common prefixes. This allows students to read long words with more confidence and to increase their comprehension by giving them strategies to decipher the meanings of long words. Also, dyslexic students learn to read silent-E words that have suffixes, even though they do not yet know how to read silent-E words without suffixes. They also can use and pronounce the suffixes ER and ABLE, even though they have not yet been taught those syllable types. At the sixth level, students are taught six reasons for a silent-E. Dyslexic students are quite confused about silent letters, which is why they tend to “decorate” with silent-E's. One unique aspect of the system of the present invention is that all six reasons for a silent-E are presented at the same level. Dyslexic students are taught not to spell using a silent-E unless needed for one of the six reasons. In the process, they learn two more types of syllables, namely, silent-E and consonant-LE. Next, at the seventh level, students learn a vowel-R syllable type, that is, students learn that the sound of a vowel followed by an R is not long or short, and changes depending upon whether or not it is accented. They also learn associated spelling rules. At level eight, dyslexic students learn advanced vowel teams, namely, the 15 other vowel teams not taught at the fourth level, most of which can represent more than one sound, and also learn associated spelling rules.

No known Orton-Gillingham-based system teaches the above material in the same order, to the same depth, or with the associated spelling rules, or teaches seven types of syllables. No known system attempts to go beyond this teaching level. None of them teaches what is taught by the system of the present invention in the following two levels. One reason the system in accordance with the present invention can go farther is tight integration with the use of the electronic spell checker.

At the ninth level, the method of the present invention teaches dyslexic students the reading and spelling rules pertaining to words borrowed from French, along with some common Greek spellings. Finally, the focus of the tenth level is on comprehension of long, high school and college level words, most of which derive from Latin or Greek. Students are taught that Greek words are typically compound words, and they learn the meaning, spelling, and combinations of Greek words. Students also learn the meaning of 24 common Latin roots, as well as how to combine them with previously learned prefixes and suffixes. They also learn the meaning of more esoteric Latin prefixes and spelling rules for Latin's “chameleon” prefixes.

One embodiment of the system in accordance with the present invention comprises various materials, including written materials that provide fully scripted lesson plans, an electronic spell checker, manipulative objects, and a word frame, that aid dyslexic students to learn to read and spell by making use of the student's visual/artistic sense and kinesthetic memory. The manipulative objects preferably comprise a set of color-coded “tiles” that correspond to “phonemes” in an alphabetic language. These tiles are used by a student and the tutor in conjunction with the written materials. Moving the tiles around on a table, for example, to form sounds or whole words, constitutes a significant component of the kinesthetic portion of the multisensory learning process, while the color coding helps focus the attention of the student on the letters in the middle of a word.

The preferred embodiment of the system in accordance with the present invention comprises a tile set that has a total of 202 tiles of at least six different types. The tile background colors correspond to the type of sound, or class of language element, they represent. For example, vowel tiles are preferably yellow, and consonant tiles are preferably blue.

The word frame aids isolation of words. The word frame comprises a card with a hole that can be positioned so that a word to be learned can be viewed through the hole.

The system in accordance with the present invention effectively teaches dyslexic students to read, spell, and write at a proficient level. By the end of the process, a dyslexic student is reading and spelling at the 9^{th} grade level, which means that he or she is equipped to pass the GED and can read most high school textbooks.

### BRIEF DESCRIPTION OF THE DRAWINGS

FIG. 1, comprising FIGS. 1A and 1B, illustrates a flow diagram of one embodiment of a method in accordance with the present invention for teaching persons with dyslexia how to read and spell.

FIG. 2 illustrates a schematic overview of one embodiment of a system in accordance with the present invention for teaching persons with dyslexia how to read and spell.

FIG. 3, comprising FIGS. 3A to 3C, illustrates an example of a facilitator video guide.

FIG. 4, comprising FIGS. 4A to 4D, illustrates an example of a facilitator's planning guide.

FIG. 5, comprising FIGS. 5A to 5FF, illustrates an exemplary lesson plan to implement the system shown in FIG. 2.

FIG. 6 illustrates a flow diagram of a lesson.

FIG. 7 illustrates a manipulative object to implement the system shown in FIG. 2.

FIG. 8 illustrates a word frame to implement the system shown in FIG. 2.

### DETAILED DESCRIPTION OF THE PREFERRED EMBODIMENTS

According to the present invention and referring now to the figures, wherein like reference numerals identify like elements of the various embodiments of the invention, one can effectively teach persons with dyslexia to read. Additionally, the system can teach dyslexics to spell, as well as write. The system enables a dyslexic student to achieve a level of proficiency so he or she has the necessary reading and spelling skills to be on a college entrance track.

The system comprises lessons based on a multisensory method of teaching that requires a dyslexic person to simultaneously use his or her auditory, visual, and kinesthetic faculties. The system develops phonemic awareness as a basic building block simultaneously integrating auditory, visual, and kinesthetic techniques.

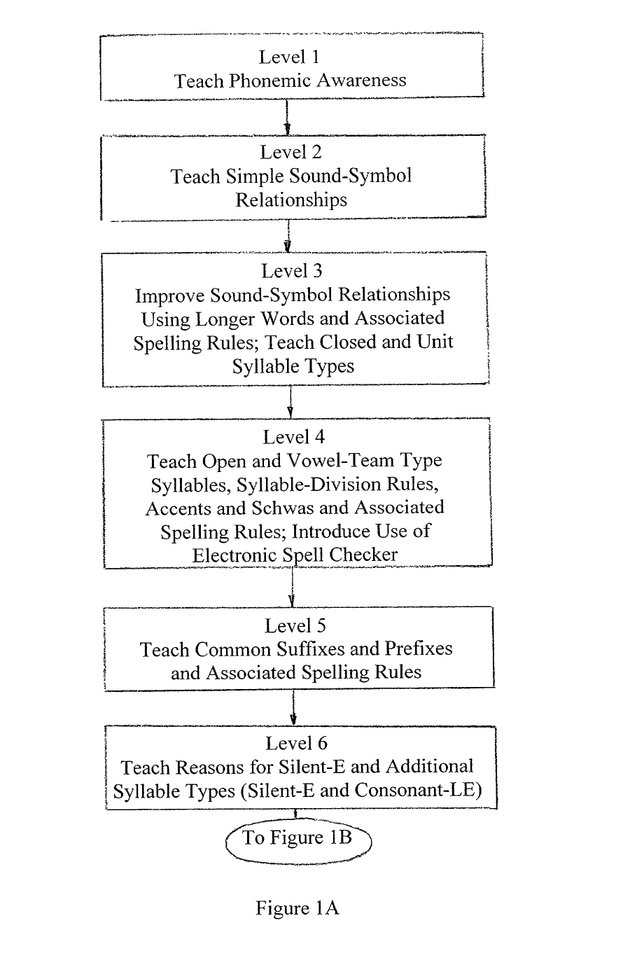

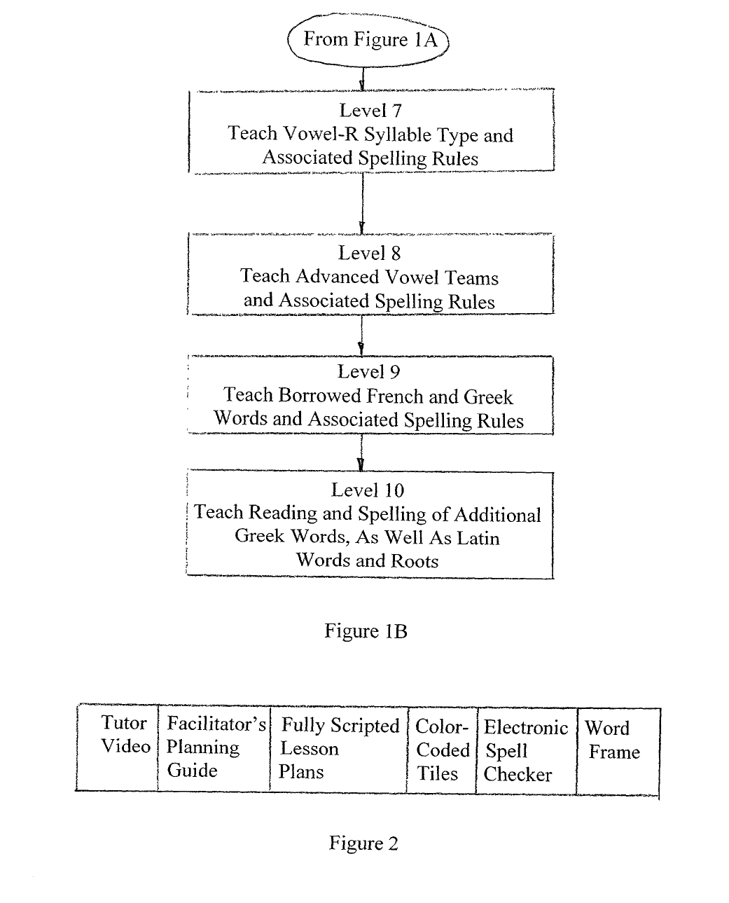

A preferred embodiment of the method in accordance with the present invention for teaching dyslexics to read and spell is shown in FIG. 1. Although known Orton-Gillingham-based systems typically eventually teach much of the same material, the order in which the method of the present invention introduces the material is unique. It has been found that the order of teaching is important. In accordance with the preferred embodiment of the present invention, the first level of the teaching sequence is phonemic awareness.

Considered in more detail, the method of the present invention teaches phonemic awareness first, that is, the first level (Level 1) is devoted to teaching persons with dyslexia phonemic awareness. The recently released research by the National Institutes of Health indicates that until dyslexics can hear each sound in a word, they will not understand what the letters represent, and will not be able to change their reading strategy to one of “decoding” an unknown word by sounding it out. Consequently, one unique aspect of the method of the present invention is to begin by teaching phonemic awareness. The method teaches phonemic awareness before any letters (visual portion) are introduced.

The method of the present invention teaches all seven essential phonemic awareness skills before letters are introduced. The seven skills are: 1) counting sounds; 2) segmenting sounds; 3) deleting sounds; 4) comparing sounds; 5) replacing sounds; 6) blending sounds; and 7) rhyming.

The method of the present invention also comprises a unique set of steps or procedures for teaching phonemic awareness. A series of three procedures that directly and explicitly teach six of the seven phonemic awareness skills has been devised. The steps are referred to as: 1) break (separate a nonsense word into individual sounds); 2) break-replace-remove (separate a nonsense word into individual sounds; substitute another sound for an identified sound in the word and blend the sounds of the reconstituted word; delete a sound from the word and blend the remaining sounds); and 3) compare (compare the sounds in two nonsense words and identify the sound that is different). These steps have proven successful with children, yet do not insult adult students.

As will be described in more detail later, a preferred embodiment of the system in accordance with the present invention comprises color-coded “tiles” that are used as learning aids. Blank colored tiles are used to raise the awareness of a dyslexic student to sounds and to make sounds visible. For example, each tile preferably represents one sound. When phonemic awareness is taught, the colors are irrelevant, except that the same color is used to indicate the same sound and different colors are used to indicate different sounds. Once a dyslexic student has shown what he or she heard using the tiles, the sound is “washed off.” The student can then re-use the tiles to demonstrate the recognition of other sounds.

Preferably, the method of the present invention includes phonemic awareness games that are devised to be played without letters. Those games (and game cards) are preferably included in Level 1.

The second level of the method of the present invention (Level 2) teaches simple sound-symbol relationships. Preferably, only short vowels in three-sound, consonant-vowel-consonant words such as dog, cat, and tax, or digraph-vowel-digraph words such as thick, for example, are employed to teach these sound-symbol relationships.

The method of the present invention is accentuated by a strong focus on spelling skills. Approximately half of the lessons that implement the method of the present invention teach spelling rules. Accordingly, as will be described in more detail later, spelling rule pages are included in the system in accordance with the present invention.

A dyslexic student learns a spelling rule much more strongly if the same rule that he or she is being taught for reading (visual) is then practiced during the spelling portion of the lesson (auditory). Accordingly, in each lesson, whatever new spelling rule is taught during the reading portion of the lesson is then reinforced and practiced during the spelling portion of the lesson.

Additionally, each spelling rule is preferably provided an easy, memorable name such as the “Milk Truck” rule. It has been found that the name of the rule is sufficient to jog the memory of a dyslexic student. Each time a new spelling rule is taught, its name is added to a list. This list is always available, as dyslexic students have a difficult time memorizing.

At the third level (Level 3), the method of the present invention improves sound-symbol relationships using longer words such as words up to six sounds in a one-syllable word with only one short vowel. Also at Level 3, the method of the present invention teaches the associated spelling rules. In the process, two types of syllables are taught, namely, closed and unit.

The present invention introduces a new type of syllable, namely, the unit syllable. Traditional Orton-Gillingham-based systems teach that American English language can be divided into six types of syllables. (The six types are: closed, open, vowel digraph, R-controlled, final stable syllable, and vowel-consonant-E.) Then, for each type of syllable, these systems teach an exception. Dyslexic students who are confused about language learn to dislike the word “exception”. So the method of the present invention avoids having to teach exceptions by creating a seventh type of syllable, called a unit syllable. A unit syllable consists of letters at the end of a word, that form an unusual sound such as ING, ALL, and ILD.

At the fourth level (Level 4), dyslexic students learn one more type of syllable, namely, open. Students are then taught the first two syllable-division rules. Next, they are taught about accents and schwas, as well as associated spelling rules.

One aspect of the method of the present invention is to be as motivating to dyslexic teen and adult students as possible. Accordingly, one goal is to enable them to read and spell multi-syllabic words as quickly as possible. At level 4, as soon as three of the seven syllable types are taught, the method of the present invention teaches syllable-division rules. At that point, dyslexic students can read and spell words with five or more syllables.

The sudden ability to read multi-syllabic words so impresses dyslexic students that they are motivated to “stay the course,” which can require as long as three years to complete. In contrast, many known Orton-Gillingham-based systems, especially those designed for young children, teach almost all of the syllable types before they teach syllable division. Adults are often de-motivated by those systems and drop out after a few months.

Also at Level 4, dyslexic students learn the last two syllable-division rules. They also learn spelling rules that apply to words with three or more syllables.

At Level 4, the method of the present invention also teaches dyslexic students one more type of syllable, namely, a vowel team. Students are shown how to use the syllable-division rules with the nine most common vowel teams.

Preferably, the system in accordance with the present invention incorporates an electronic spell checker and thus uses new technology to teach spelling rules. The electronic spell checker is used beginning at Level 4. The electronic spell checker can be used to look up words phonetically, that is, by how they sound, not simply by how they are spelled. This lowers the frustration level of dyslexic students, because students often cannot look up words in a dictionary since they cannot typically memorize the alphabet. Students can also look up foreign words using American spellings. For example, they can enter VOAG, and the electronic spell checker will display VOGUE. They can also look up words containing silent letters or unusual spellings by entering just the sounds they hear, such as NABER for NEIGHBOR. This is also useful when one sound can be spelled multiple ways. The sound/air/, for example, can be spelled pare, pair, paragraph, dictionary, marry, or merry. Students are taught to look up words with their electronic spell checkers using the most common spelling such as PAIRAGRAF for PARAGRAPH. The system of the present invention is the only system to integrate an electronic spell checker into a reading and spelling system for dyslexic students. This tightly integrated technology tool enables the system in accordance with the present invention to take students beyond what is taught by known Orton-Gillingham-based systems.

The method of the present invention next teaches the meaning of the 15 most common suffixes followed by the 12 most common prefixes at the fifth level (Level 5). The associated spelling rules are also taught. This allows dyslexic students to read long words with more confidence and to increase their comprehension by giving them strategies to decipher the meaning of long words.

The electronic spell checker advantageously allows teaching spelling options for prefixes and suffixes. For example, /shun/ can be spelled TION or SION. Simple rules are provided to minimize when dyslexic students must look up a word. For example, only if /shun/ comes after an N or a short vowel do students have to look up the word. They use the electronic spell checker when there are options. For example, using the electronic spell checker, they can enter /?ion/ for the last four letters.

At the sixth level (Level 6), the method of the present invention teaches six reasons for a silent-E. Because dyslexic students cannot hear silent letters such as silent-E, they tend to “decorate” with silent-Es, inserting them here and there at random when they write. This ceases by the end of Level 6, because students learn that “If you can't think of a reason, don't add a silent-E.” In the process, students learn two more types of syllables, namely, silent-E and consonant-LE.

The method of the present invention teaches dyslexic students how R affects the sound of vowels at the seventh level (Level 7), that is, the vowel-R type of syllable. Students learn that the sound of a vowel followed by an R changes depending upon whether or not the vowel is accented. Students also learn associated spelling rules.

At described earlier, dyslexic students learned the nine most common vowel teams at Level 4. At the eighth level (Level 8) they are taught advanced vowel teams, that is, the 15 other vowel teams, most of which make more than one sound. Students also learn associated spelling rules.

The method of the present invention also uses the electronic spell checker extensively to teach the distinctions between homonyms such as pour, pore, and poor. This allows dyslexic students to achieve a 9^{th} grade writing level.

Known Orton-Gillingham-based systems not only differ in the steps used to teach dyslexic students, but they also stop after advanced vowel teams are taught. In contrast, the method of the present invention preferably continues and uniquely teaches at least two additional levels, including the following.

By way of background, English borrowed most of its words from three languages: Latin, Greek, and French. Dyslexic students need to be able to read, spell, and comprehend these words to graduate from high school.

At the ninth level (Level 9), the method of the present invention teaches dyslexic students reading and spelling rules pertaining to words borrowed from French. They are also taught various common Greek spellings.

The focus of the tenth level (Level 10) in accordance with the method of the present invention is comprehension of long, high school and college level words, most of which derive from Latin or Greek. Dyslexic students are taught that Greek words are almost always compound words. They learn the meaning, spelling, and combinations of Greek words.

Latin is different. Latin words typically have a base word, along with a prefix and often a suffix. At Level 10, dyslexic students learn the meaning of 24 common Latin roots, and how to combine them with previously learned prefixes and suffixes. They also learn the meaning of more esoteric Latin prefixes and the spelling rules for Latin's “chameleon” prefixes at the tenth level.

In summary, by the end of instruction provided by the method of the present invention, dyslexic students are reading and spelling at the 9^{th} grade level, which means they are equipped to pass the GED and can read most high school textbooks. This provides a proficiency that allows students to be on a college entrance track.

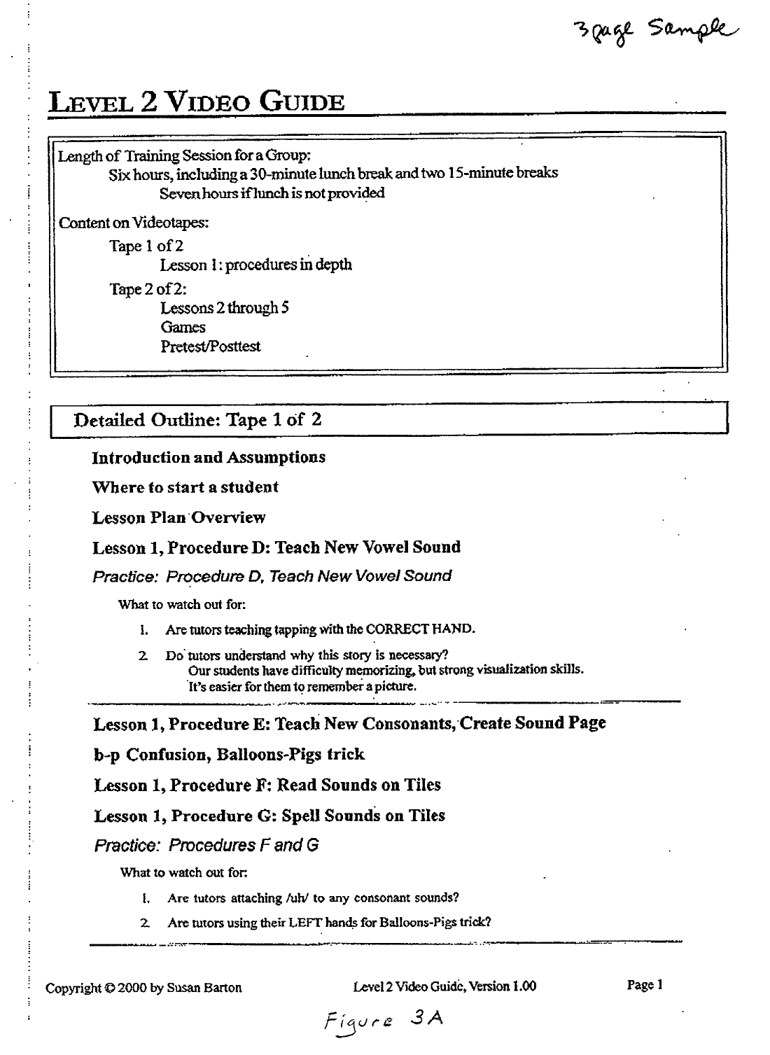

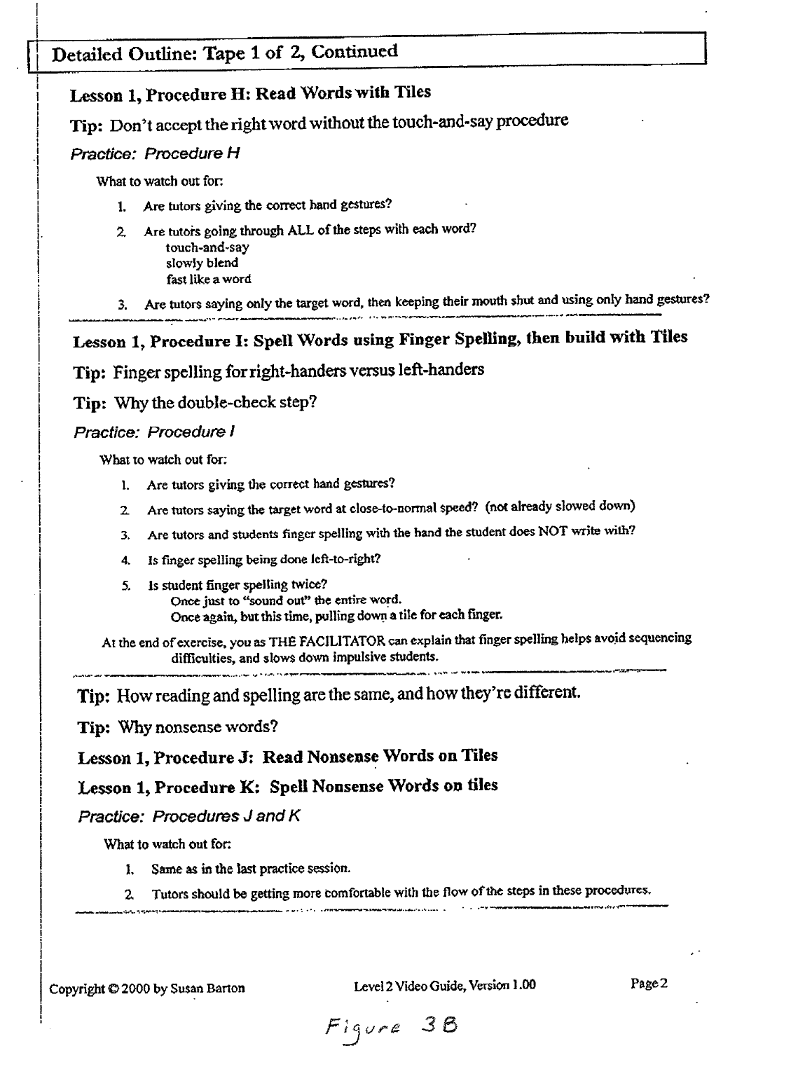

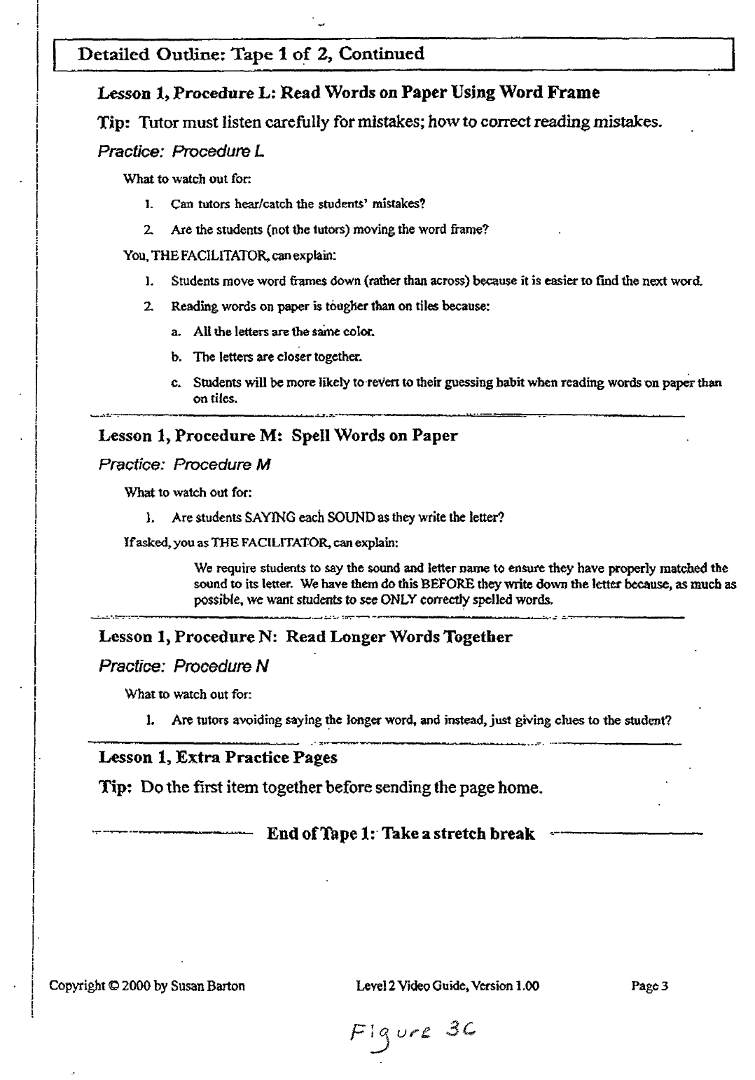

One embodiment of the system in accordance with the present invention provides a complete instructional system, as shown in FIG. 2. Each level (Levels 1-10) contains tutor training on videotape, fully scripted lesson plans (including spelling rule pages), an electronic spell checker, color-coded tiles, and preferably a word frame. These elements will be described in more detail below. In contrast, no known Orton-Gillingham-based system provides all of these elements.

The first element of the system is in-depth tutor training on videotape. The system of the present invention is the only Orton-Gillingham-based system that provides in-depth, step-by-step tutor training on videotape. At most, other Orton-Gillingham-based systems provide only a one-hour videotape overview.

Each level taught by the method of the present invention (Levels 1-10) includes four to five hours of tutor training on videotape. Each videotape preferably contains the following unique elements.

A “New Teaching” portion of each lesson to be taught to a student is shown on videotape for the given level. The videotapes are carefully crafted to work well whether training a group of tutors or an individual tutor.

Each videotape comprises a unique interface for ease of use in re-watching a specific topic. In a preferred embodiment of the system of the present invention, along the left side and across the bottom of each videotape, labels inform the viewer exactly what is being taught or demonstrated.

Each procedure is explained on videotape, then demonstrated with a dyslexic student for the purpose of simulation. A tutor watching the videotape then pauses or stops the videotape and practices.

For example, each spelling rule is explained, then demonstrated with a dyslexic student. The tutor can then stop the videotape, pull out exercise sheets, and attempt to apply those spelling rules. They compare their answers to the answer sheets provided with the videotape.

The system in accordance with the present invention preferably comprises a facilitator's video guide, if an organization plans to show the videotapes at a group training session. The facilitator's video guide, an example of which is shown in FIG. 3, is an outline of the sequence of skills presented on the videotapes.

Considered in more detail, for each “Practice” exercise, the facilitator's video guide lists three or four items that a facilitator should watch for (and, if necessary, correct) during that practice session. The facilitator's video guide also contains hints of when to take a break, along with suggestions for breaking the training into two sessions instead of one. No known Orton-Gillingham-based system provides such a guide, because no other system provides tutor training on videotape.

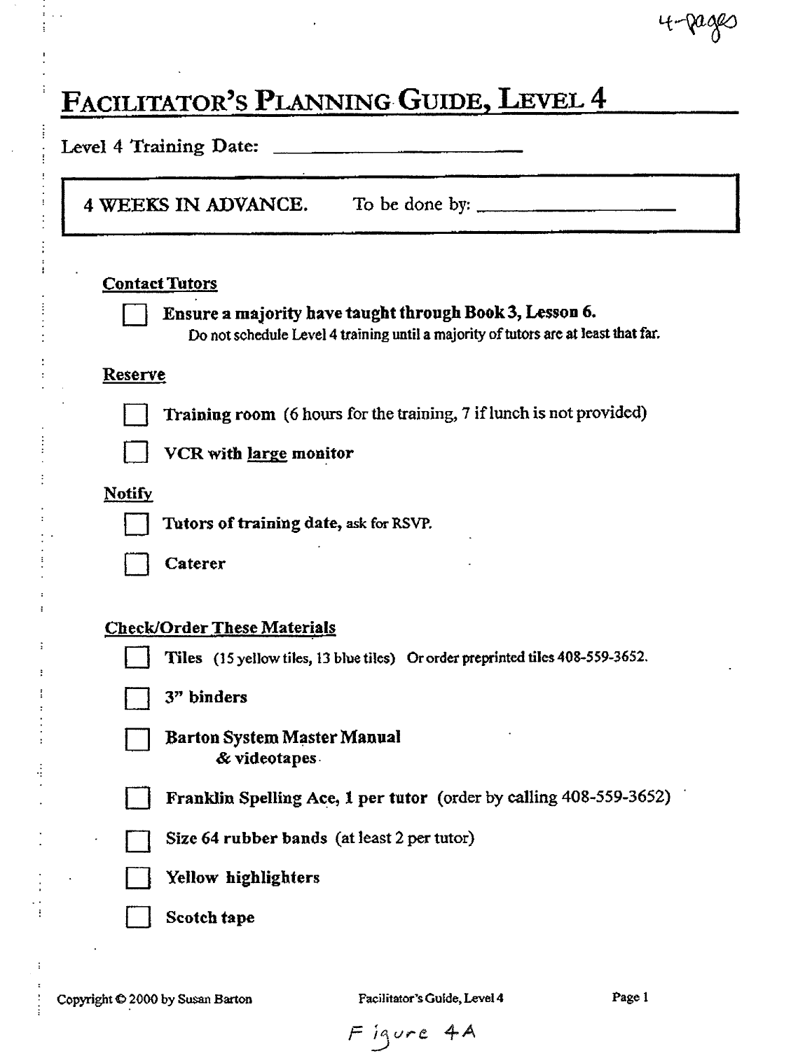

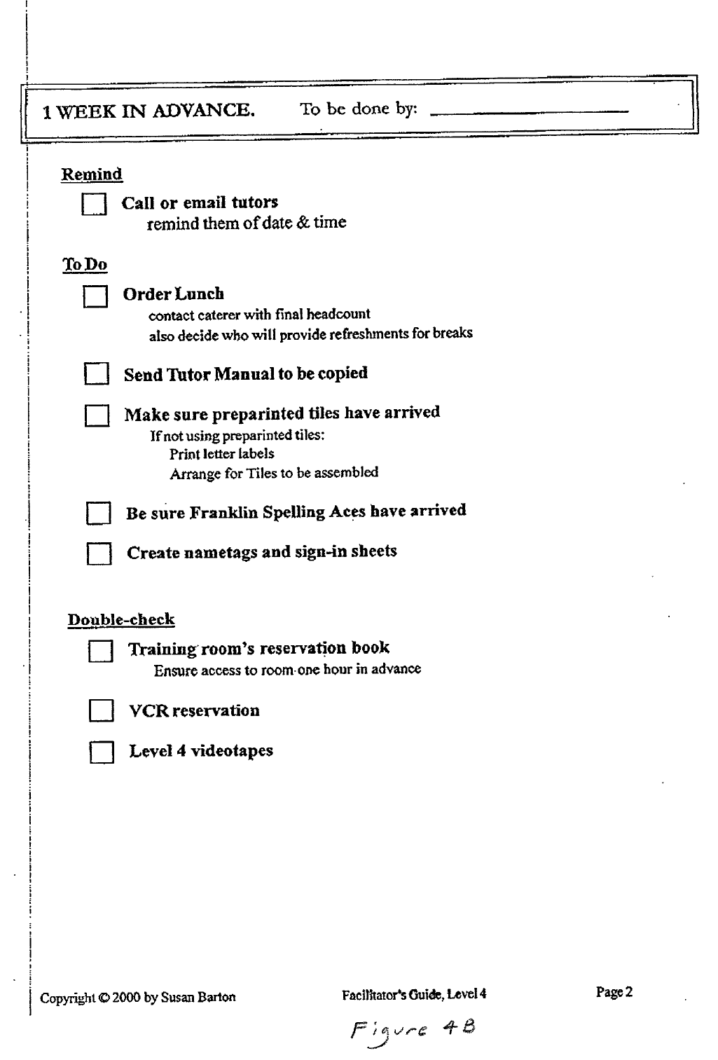

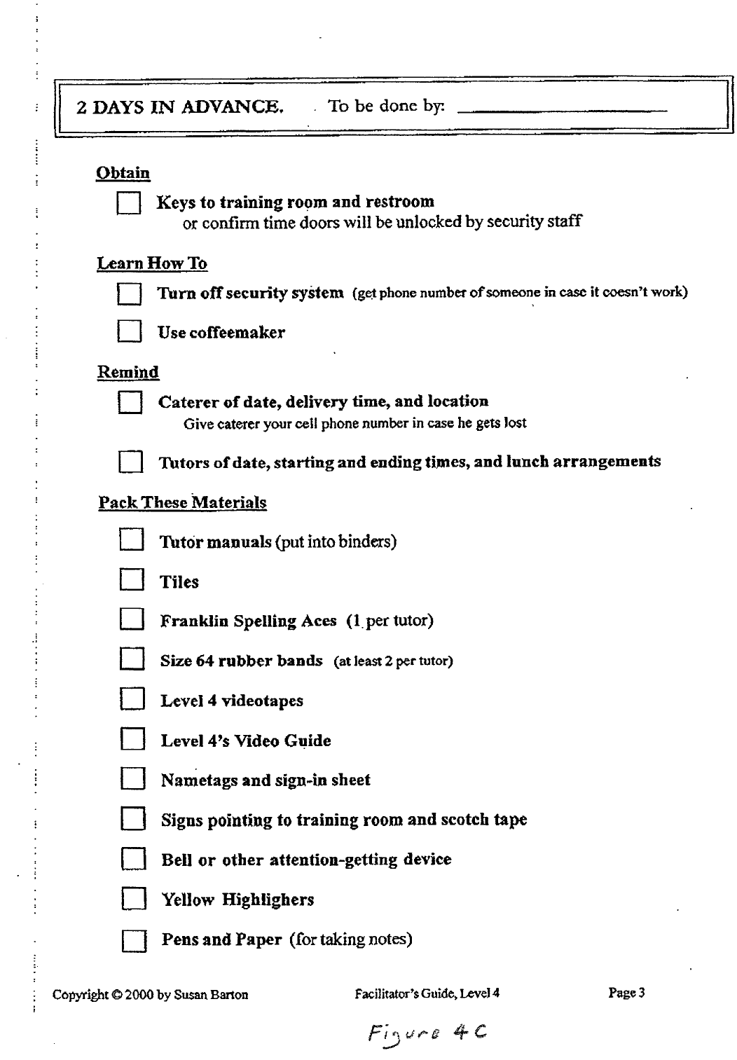

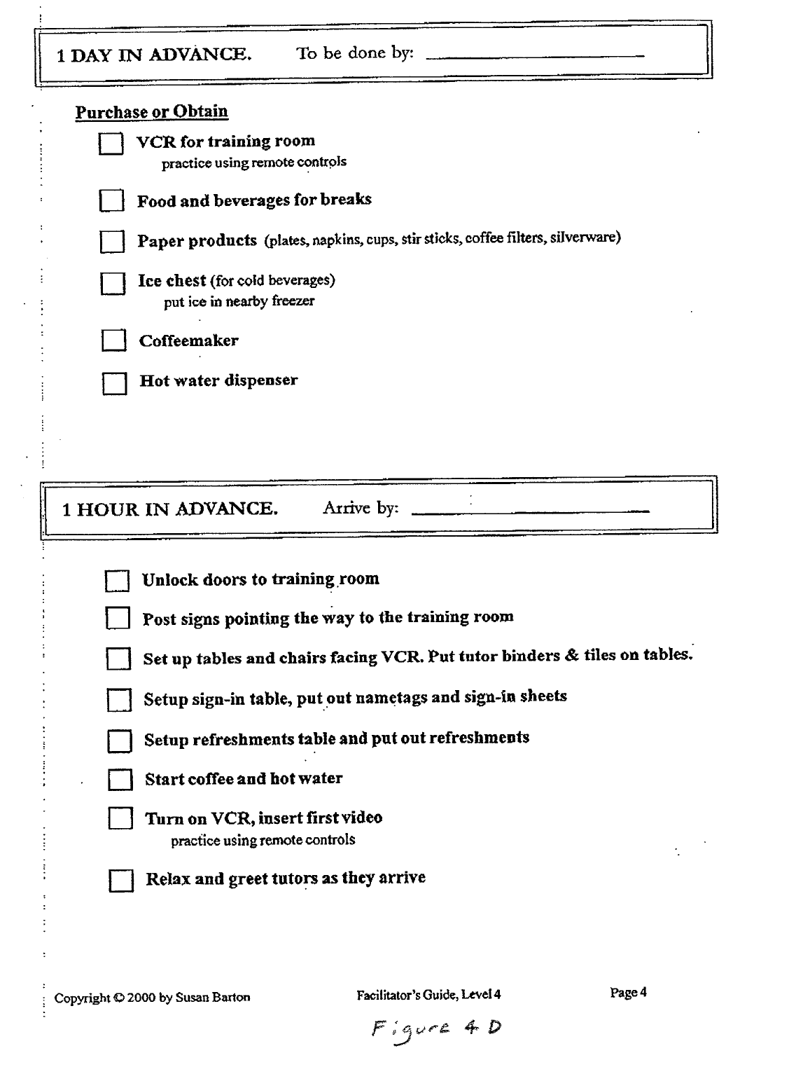

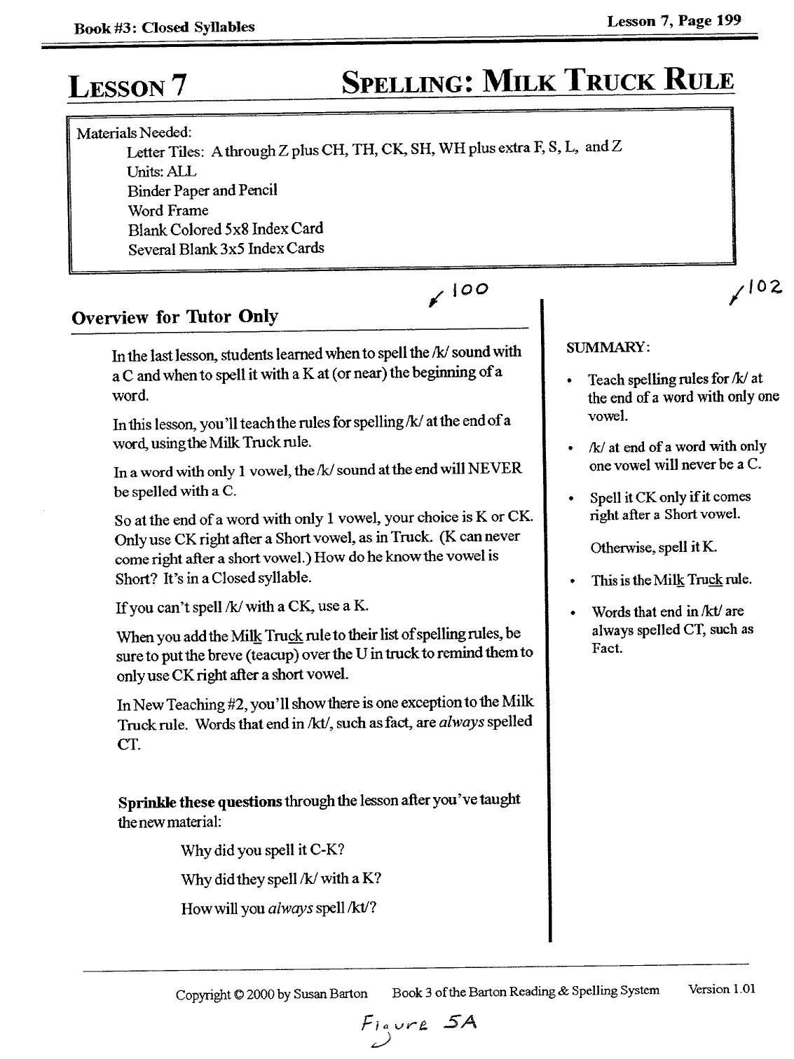

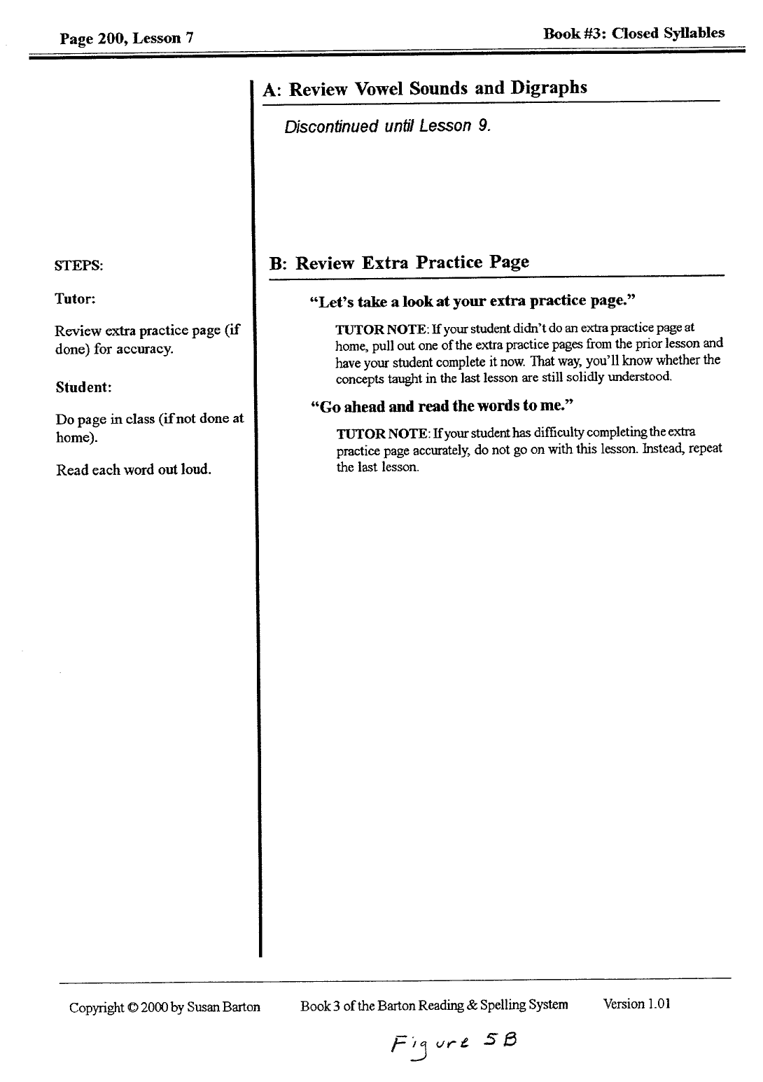

Additionally, the system of the present invention preferably comprises a facilitator's planning guide, an example of which is shown in FIG. 4. Facilitators, who have not conducted group training sessions before, need help knowing how far in advance of the actual training day certain tasks must be performed. The system of the present invention provides this information. In contrast, known Orton-Gillingham-based systems require hiring certified trainers. Those trainers work with the local on-site coordinator to accomplish these tasks.

Each level (Levels 1-10) preferably comprises fully scripted lesson plans, as shown in FIG. 2. Instructional content needed for each lesson is in one place, in logical order. The components of each lesson comprise: 1) a review of material taught in the last lesson; 2) a phonemic awareness warm-up exercise; 3) a fully scripted “Teaching A New Concept” section; 4) lists of real and nonsense reading and spelling words to practice the new concept using tiles; 5) a page of printed words in isolation for reading practice; 6) a list of real and nonsense spelling words to write on paper; 7) a page of phrases for reading practice; 8) six phrases for spelling practice; 9) a page of sentences for reading practice; 10) six sentences for spelling practice; 11) four “controlled text” stories (two for children and two for adults); and 12) two homework (or extra practice) pages. Each lesson plan contains a “FOR A REPEAT LESSON” section so a tutor can conduct a lesson twice without having to re-use the same words, phrases, or sentences.

The lesson plans are contained on pages that have a unique layout and collectively comprise a tutor's manual. The layout of pages in the lesson plan manual is based on three criteria. The first criterion is that the system of the present invention is designed for home school parents. The second criterion is that because dyslexia runs in families, the system of the present invention accommodates a parent who might also have dyslexia. That is, the lesson plans are uniquely designed to accommodate tutors who may be and often are dyslexics themselves. The third criterion is that the system of the present invention provides professionally designed, skillfully crafted lesson plans based on thorough research and experience, because volunteer tutors and home school parents may not know how to create lesson plans.

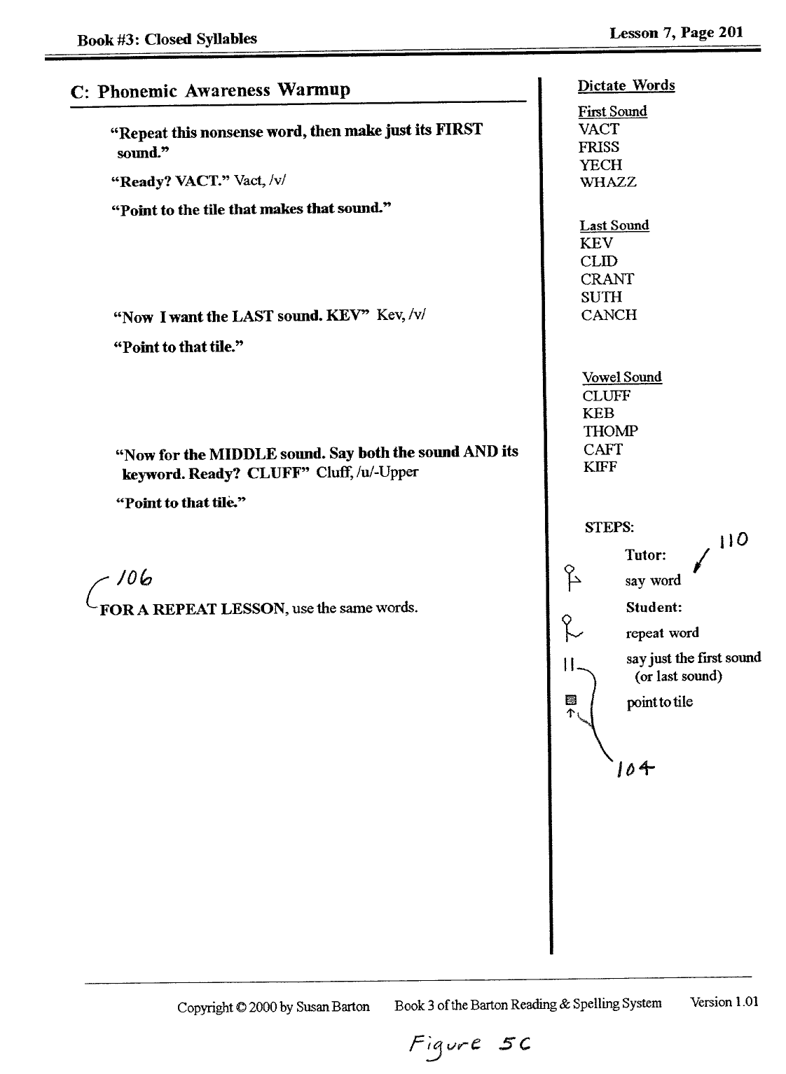

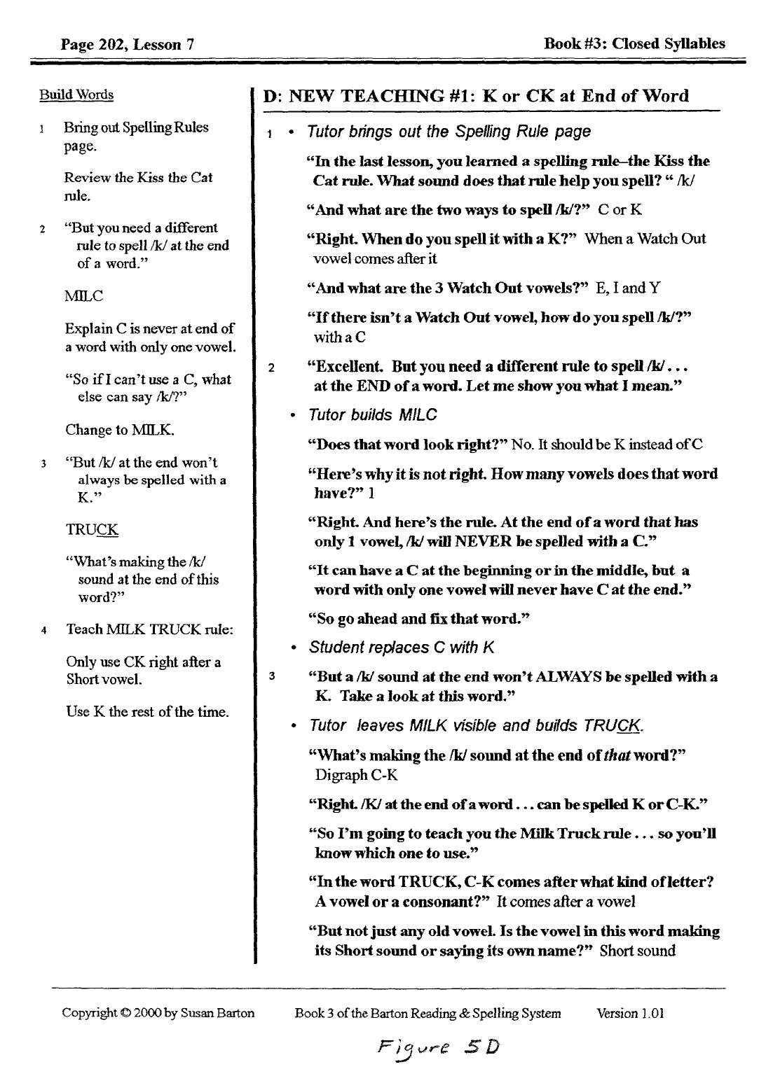

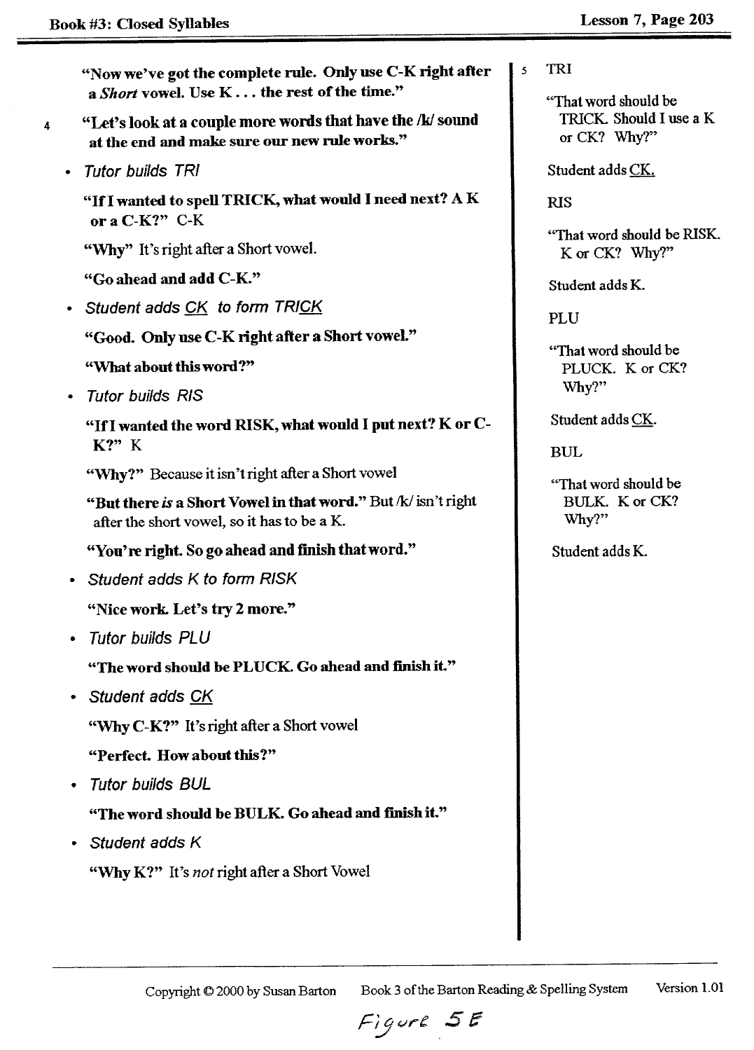

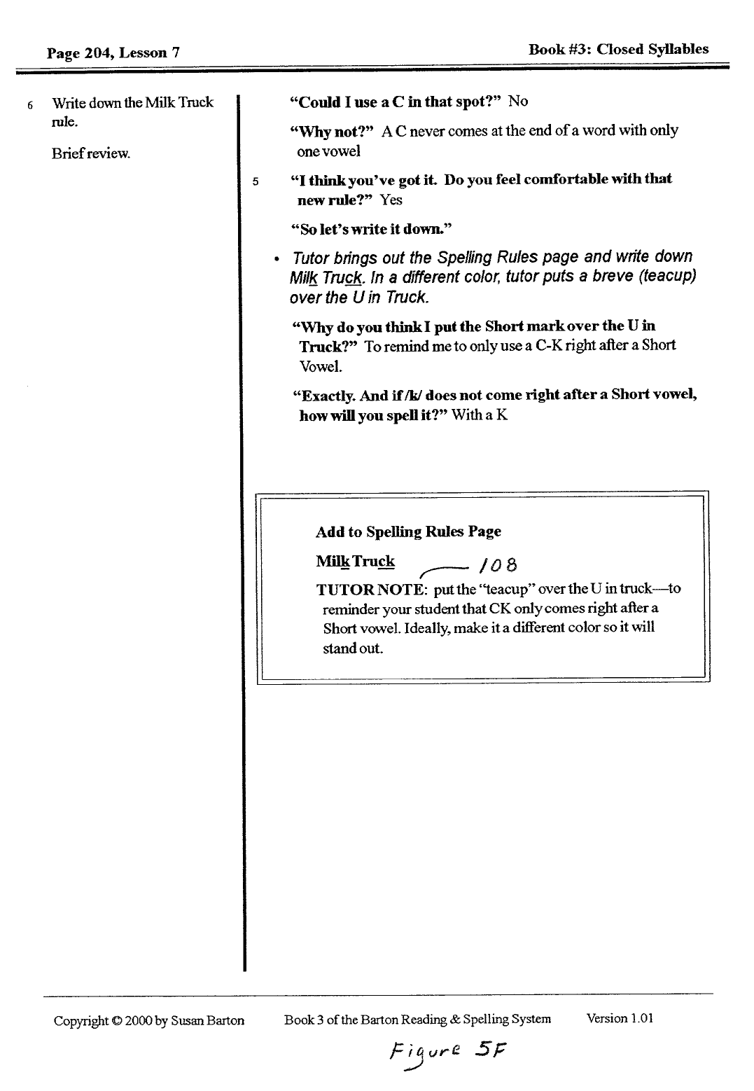

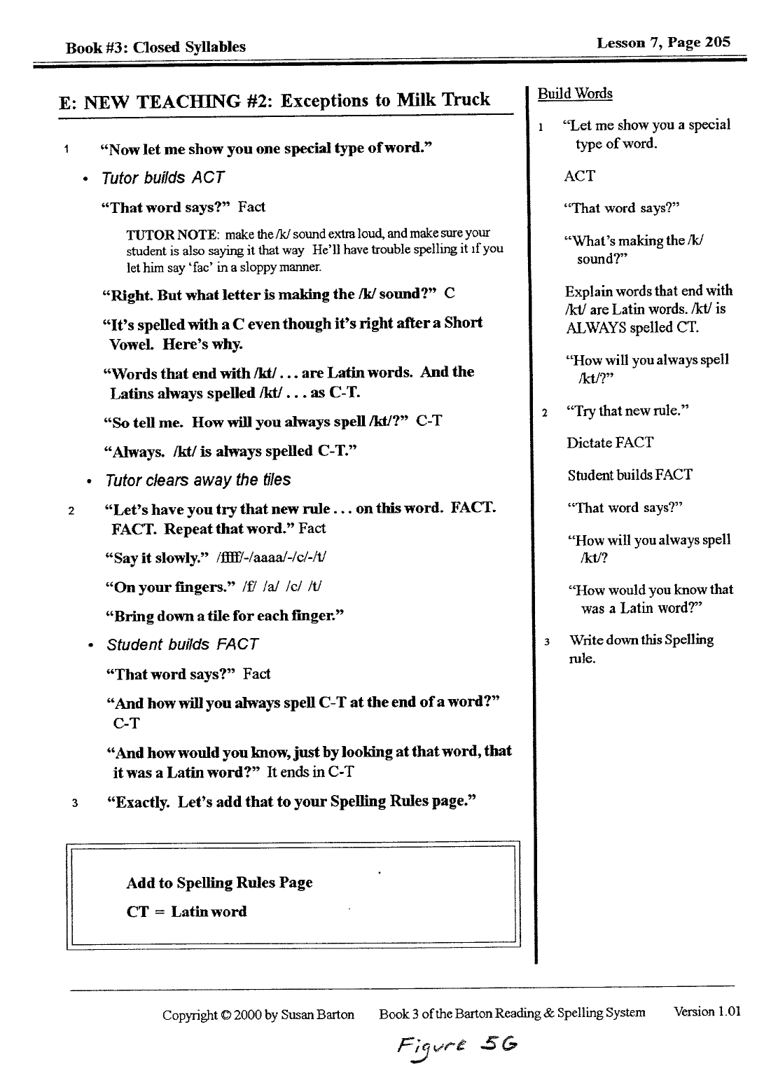

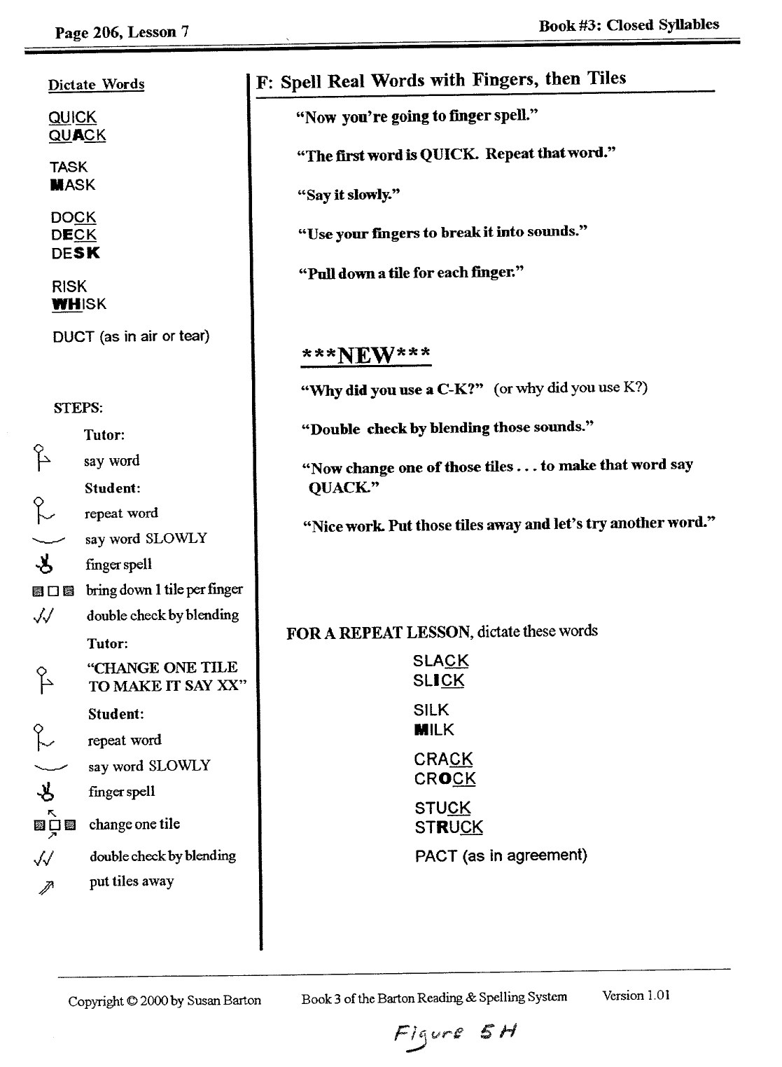

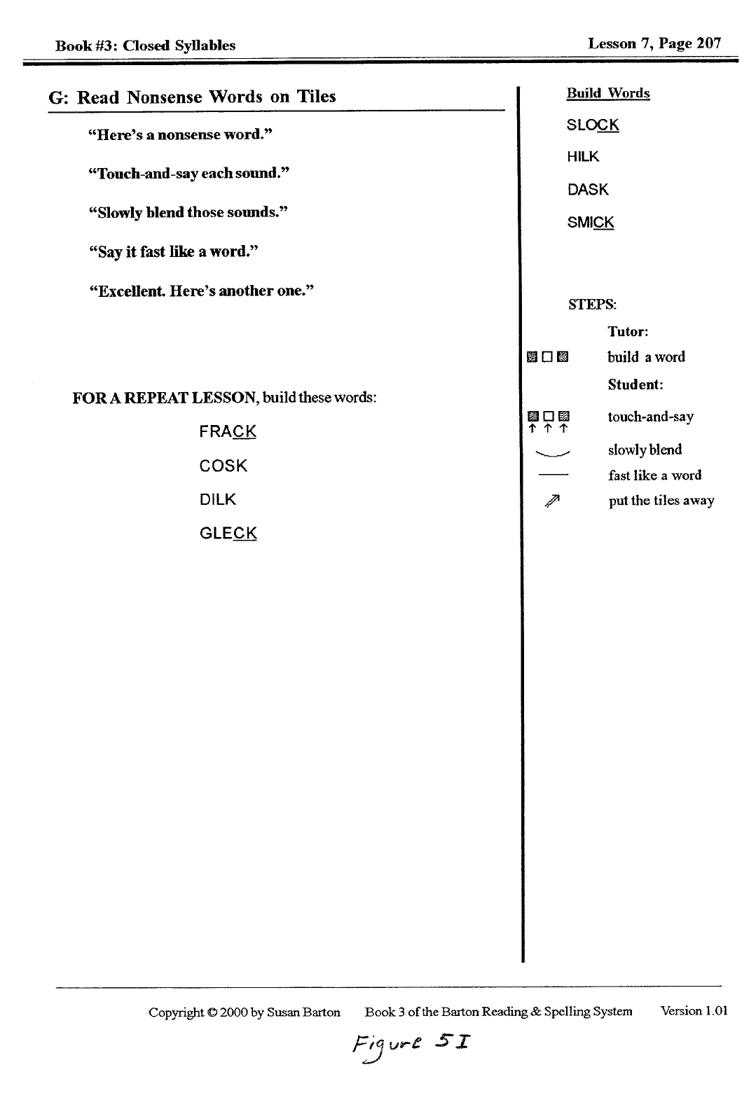

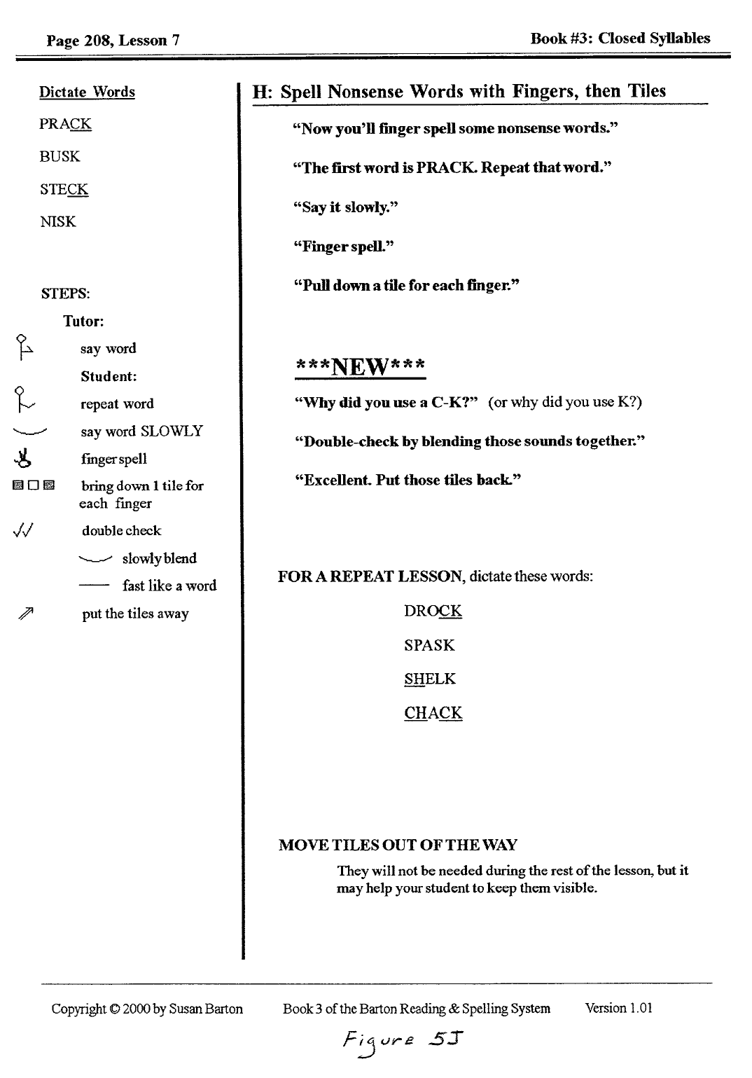

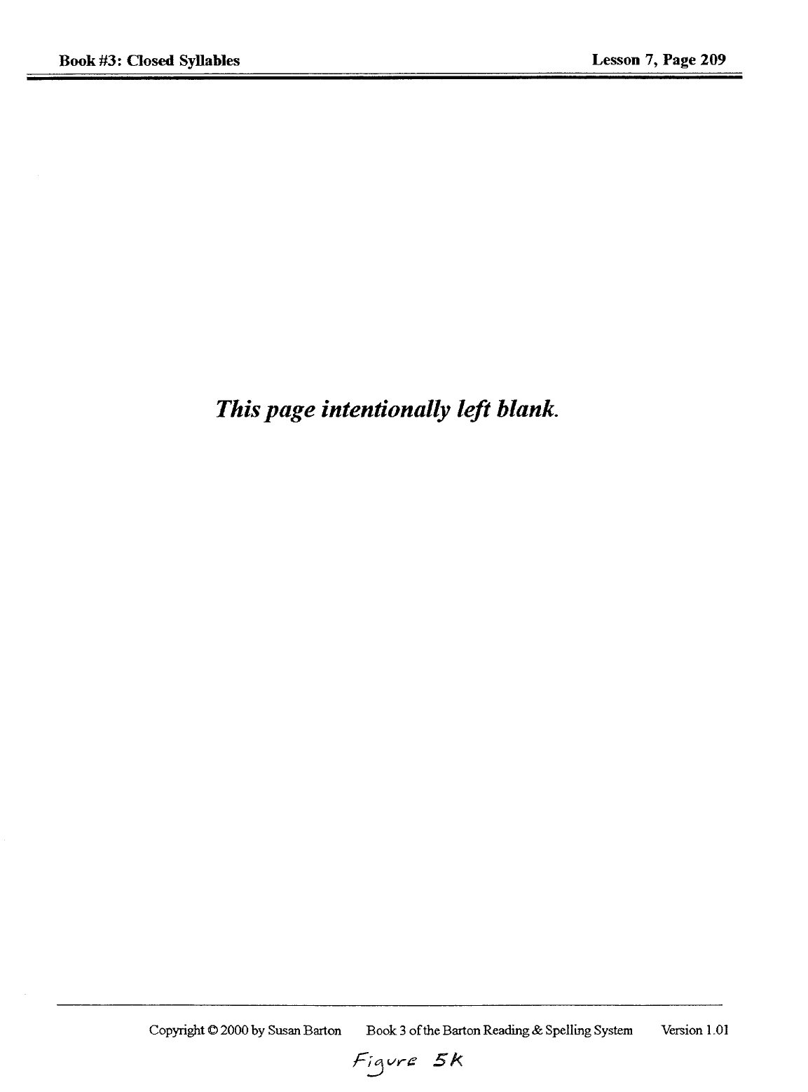

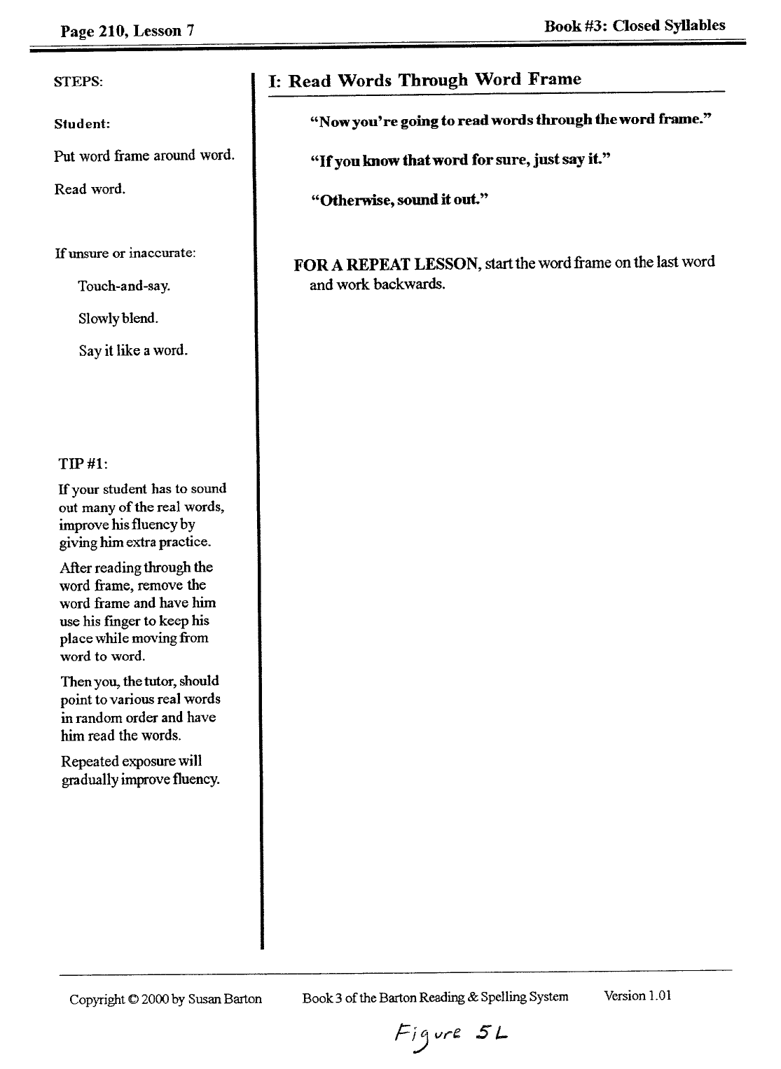

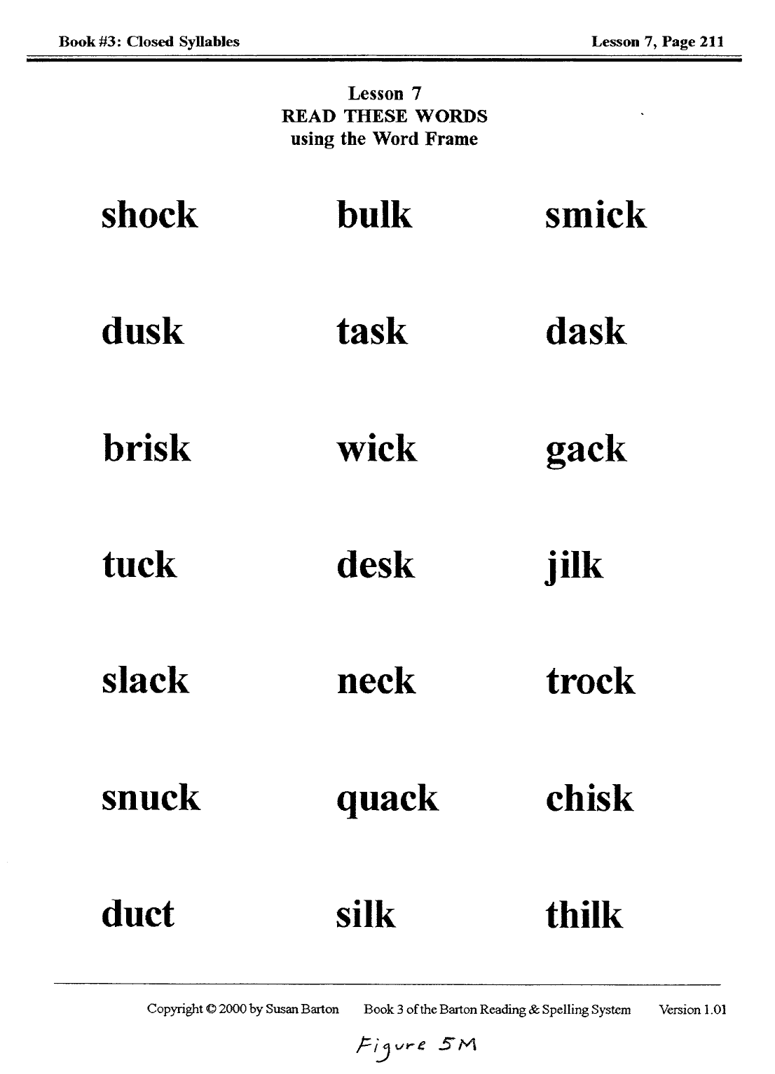

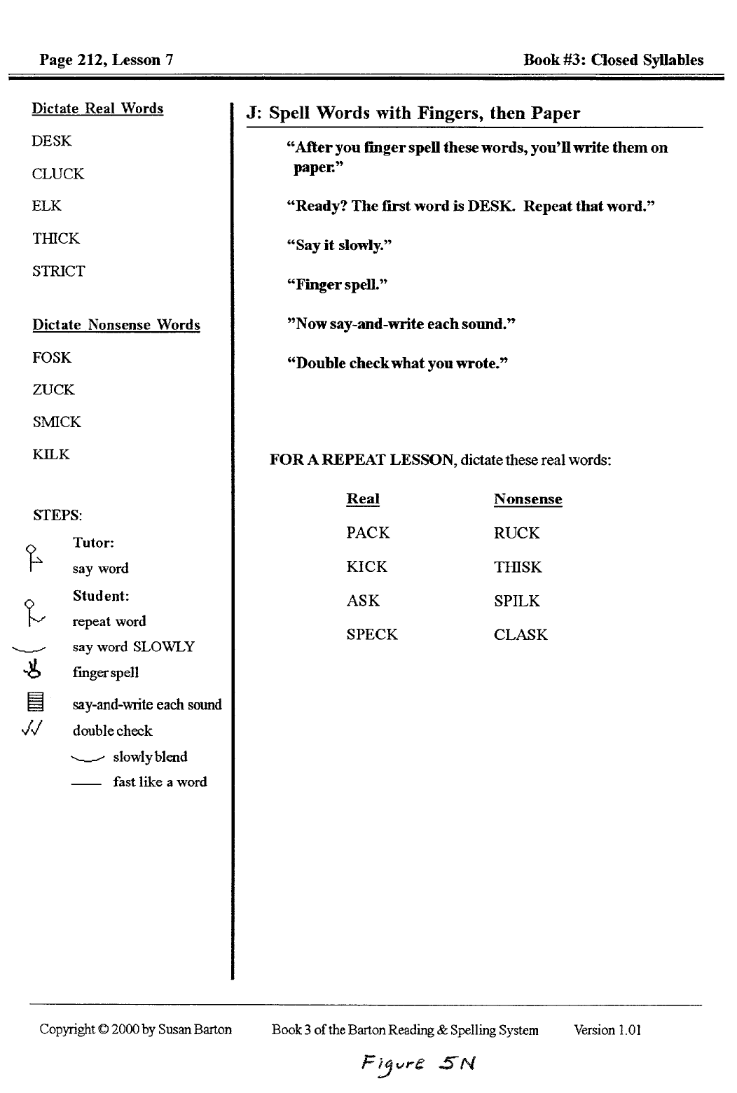

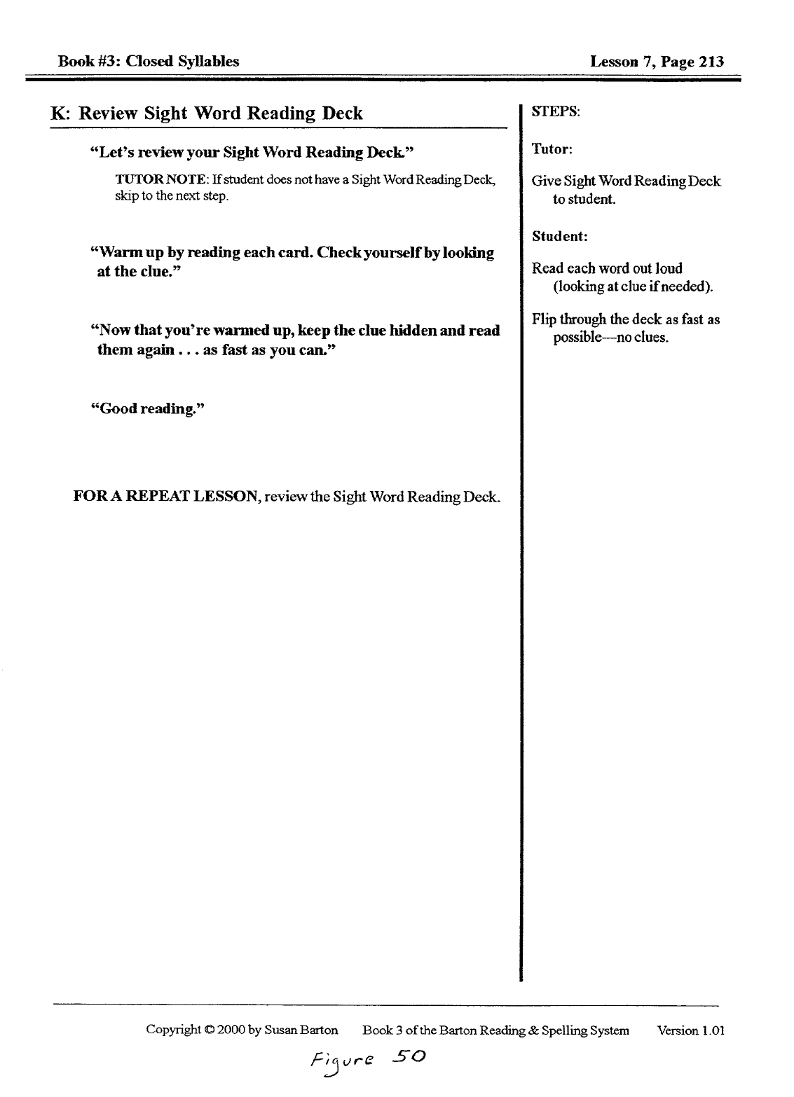

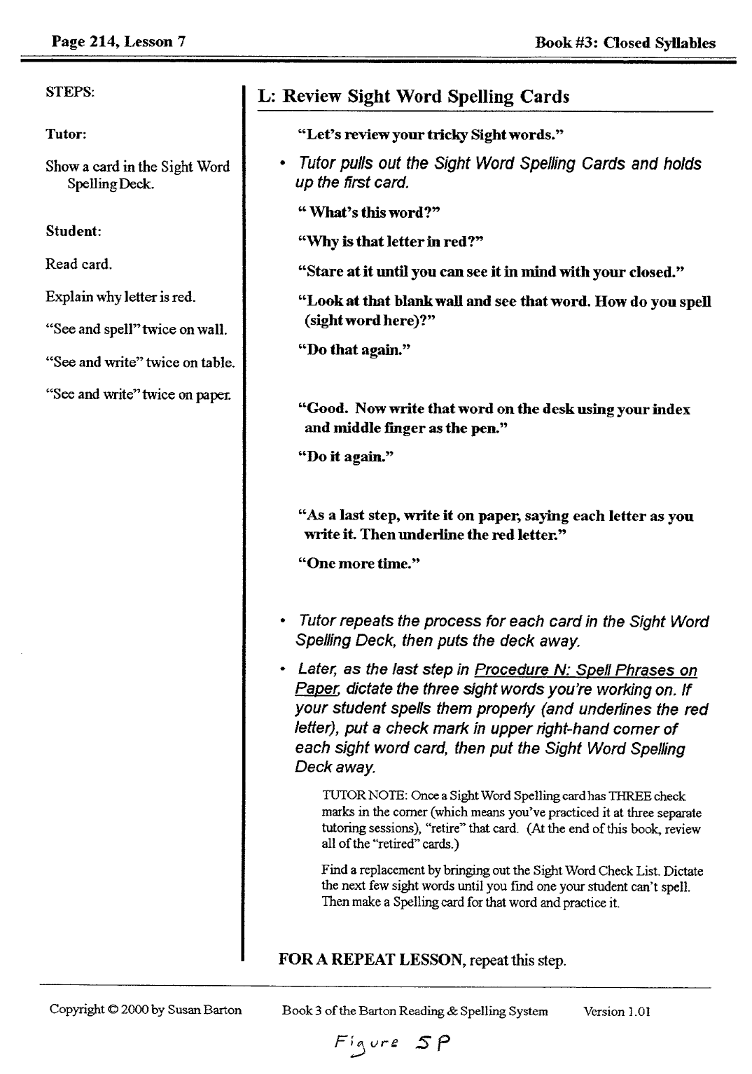

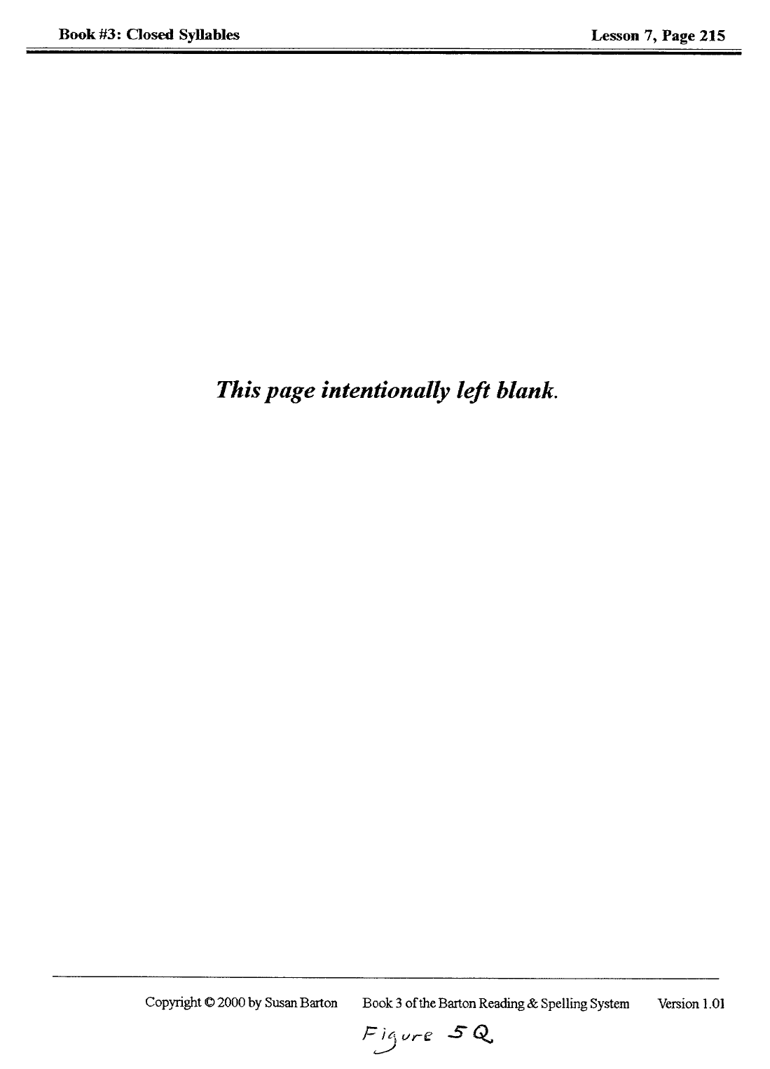

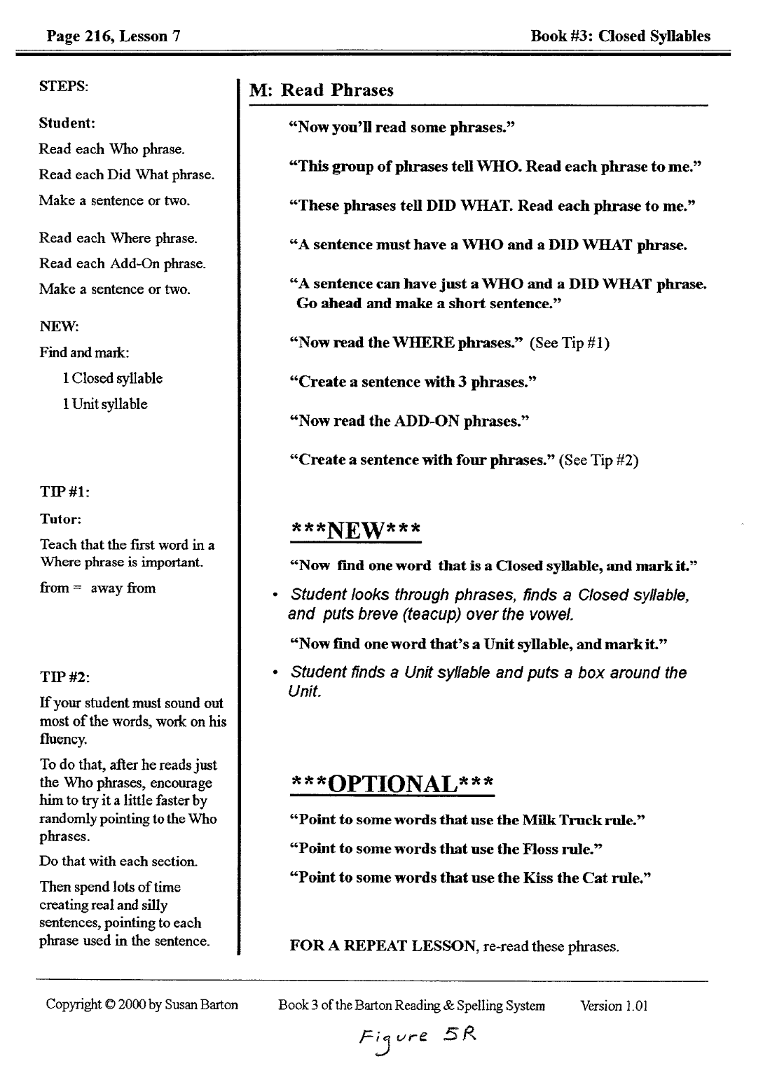

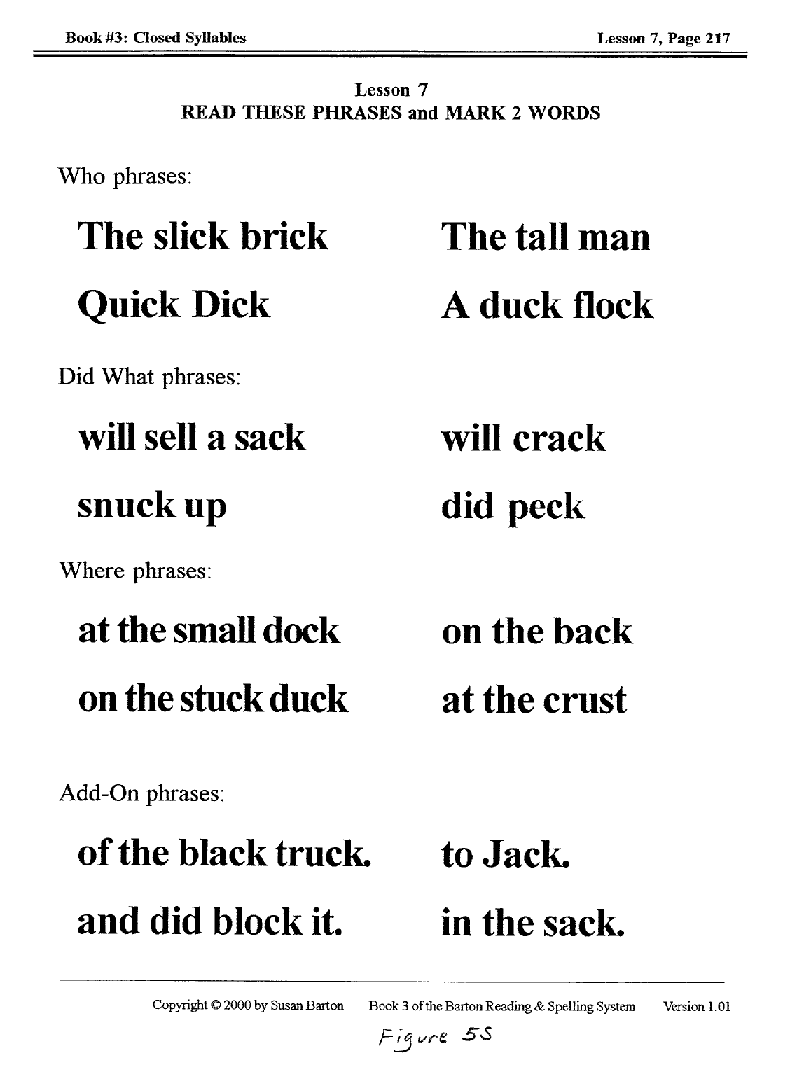

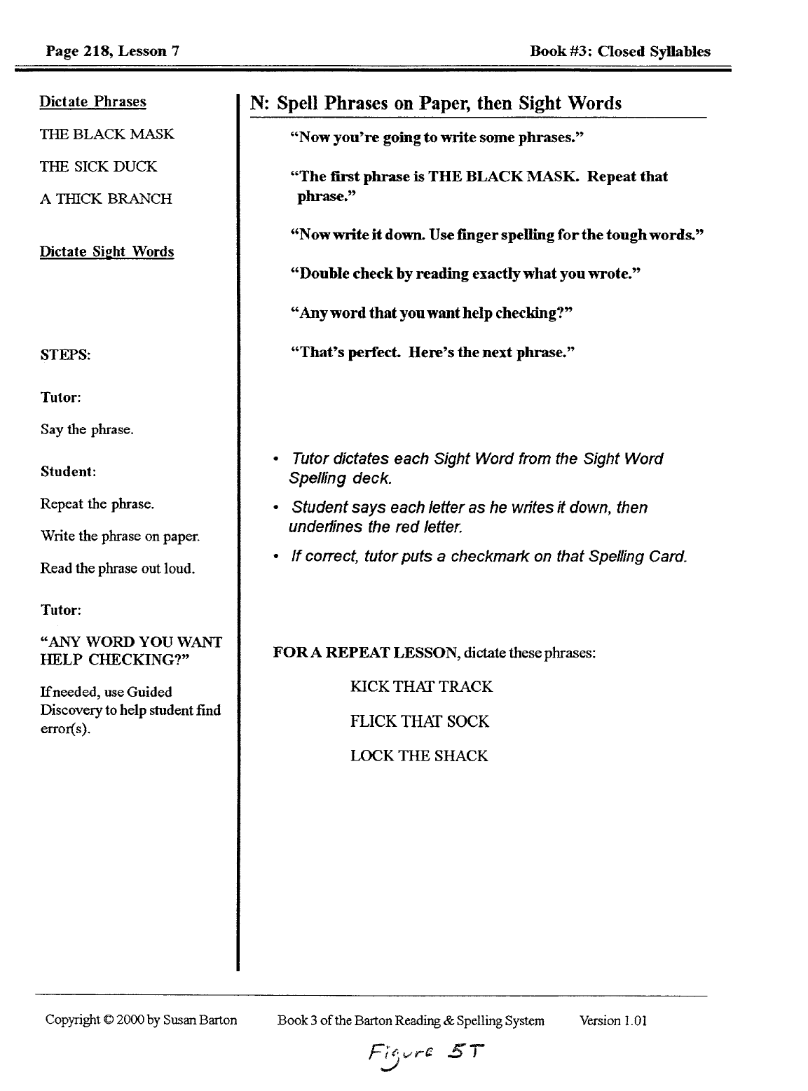

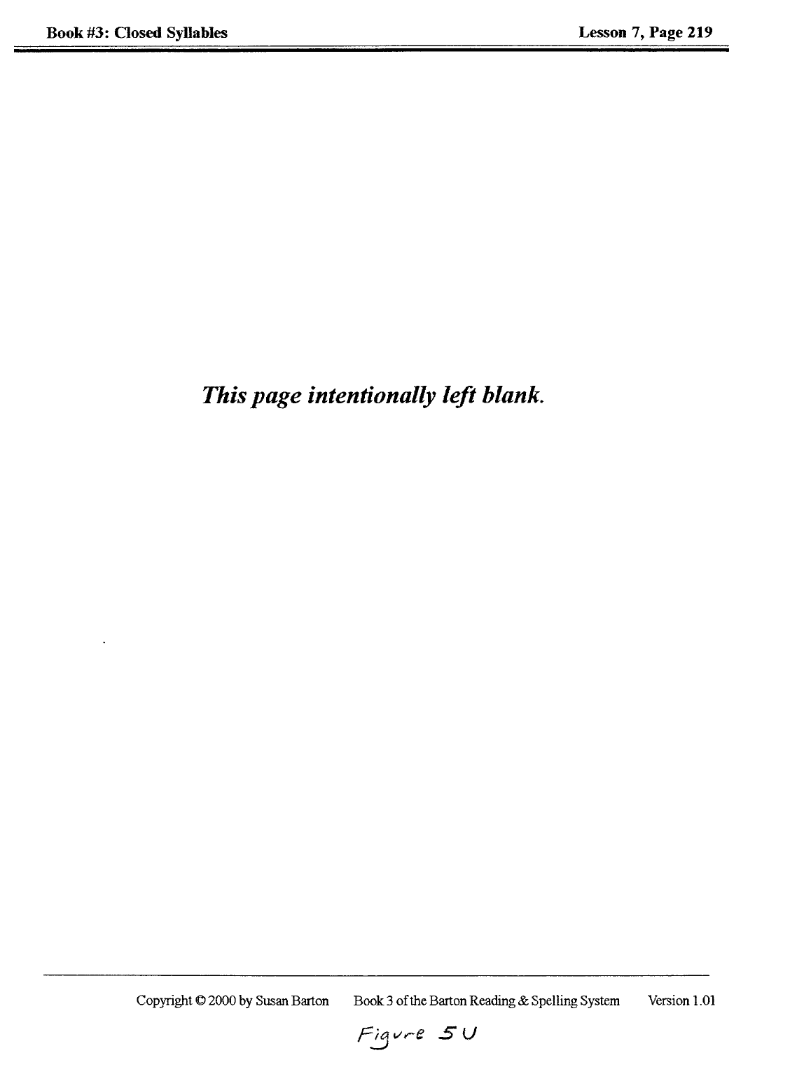

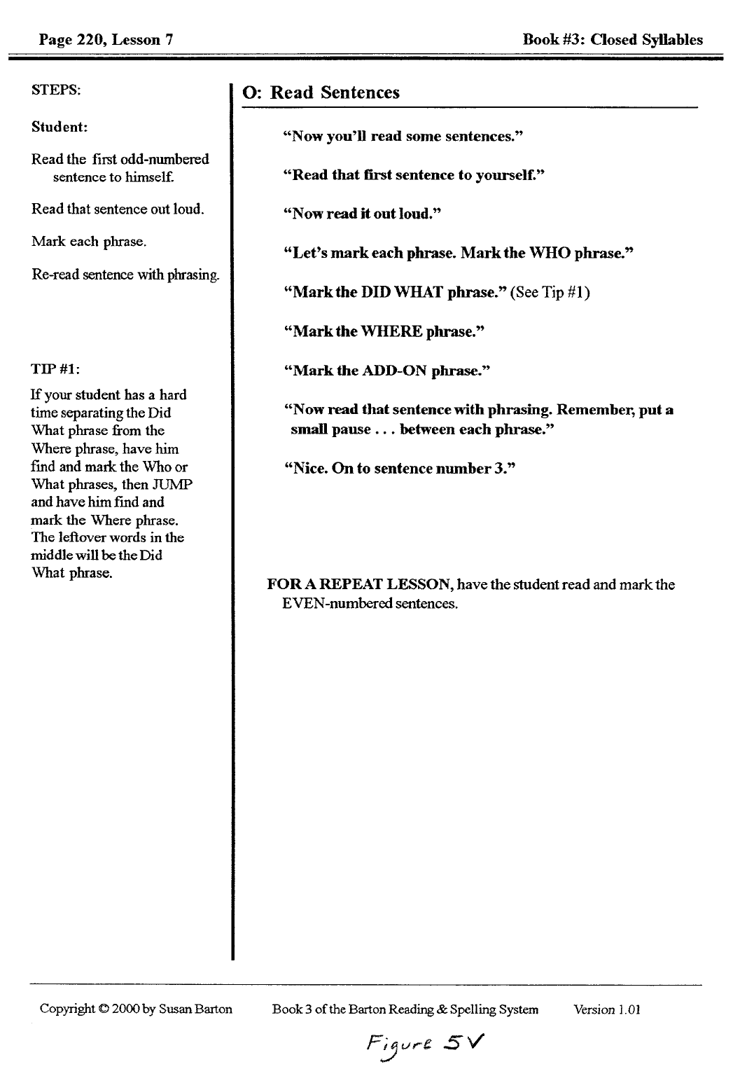

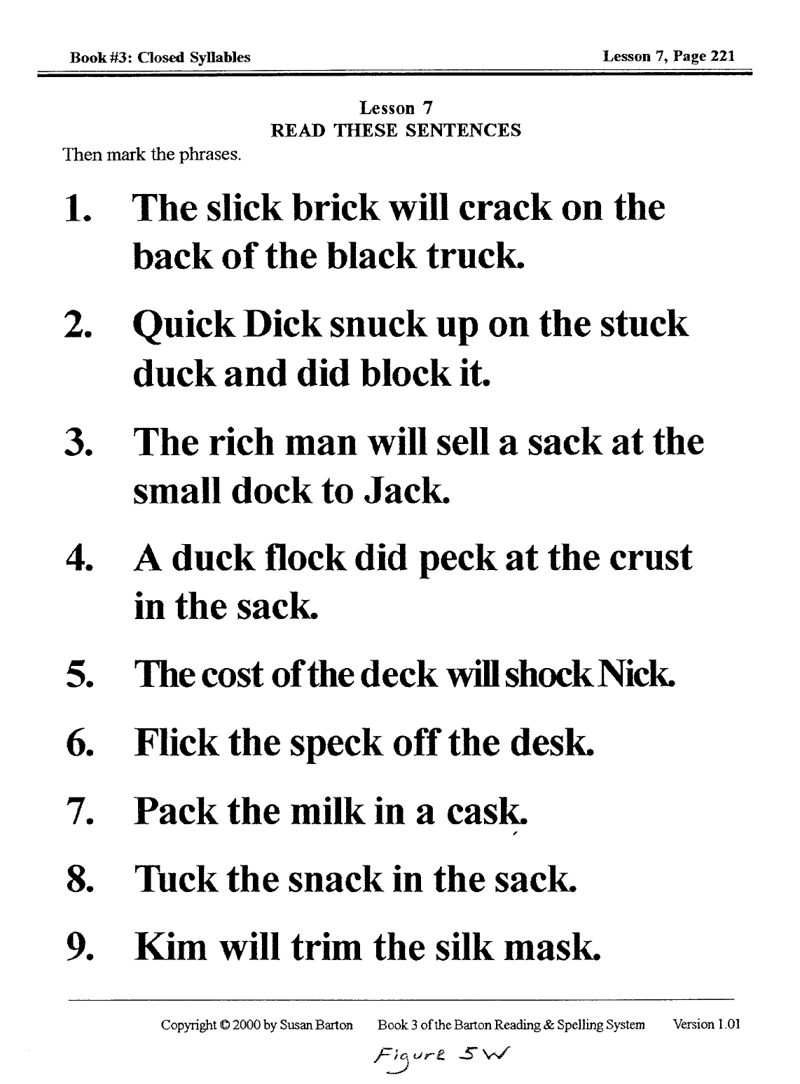

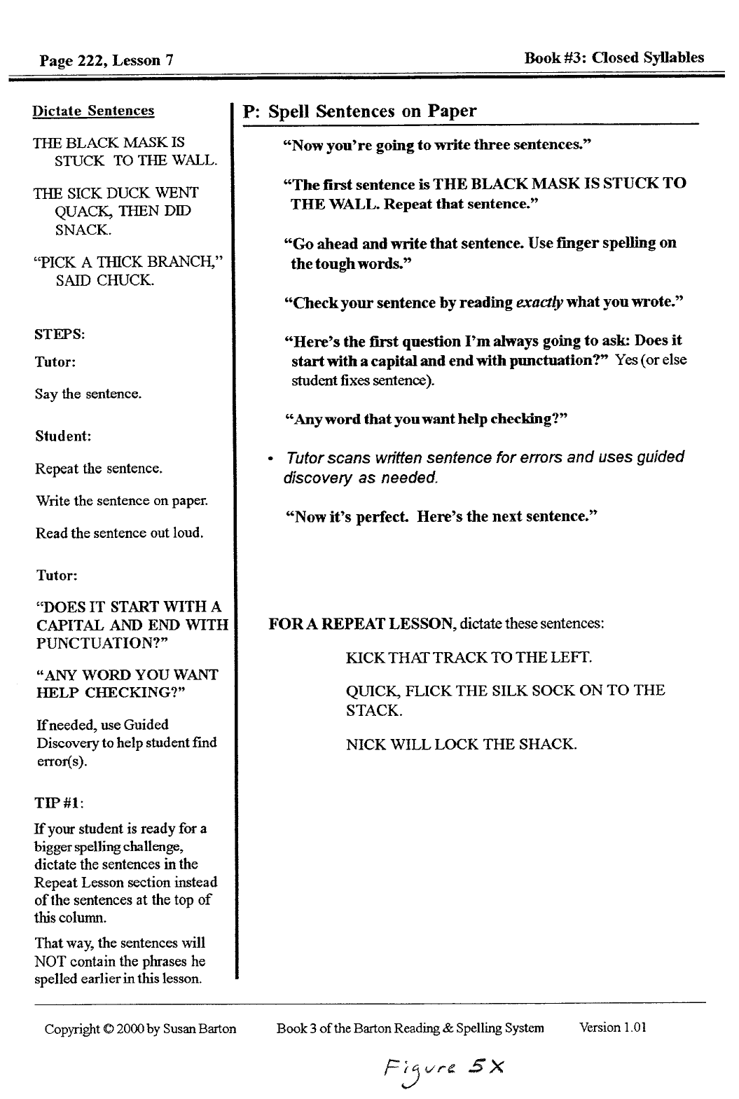

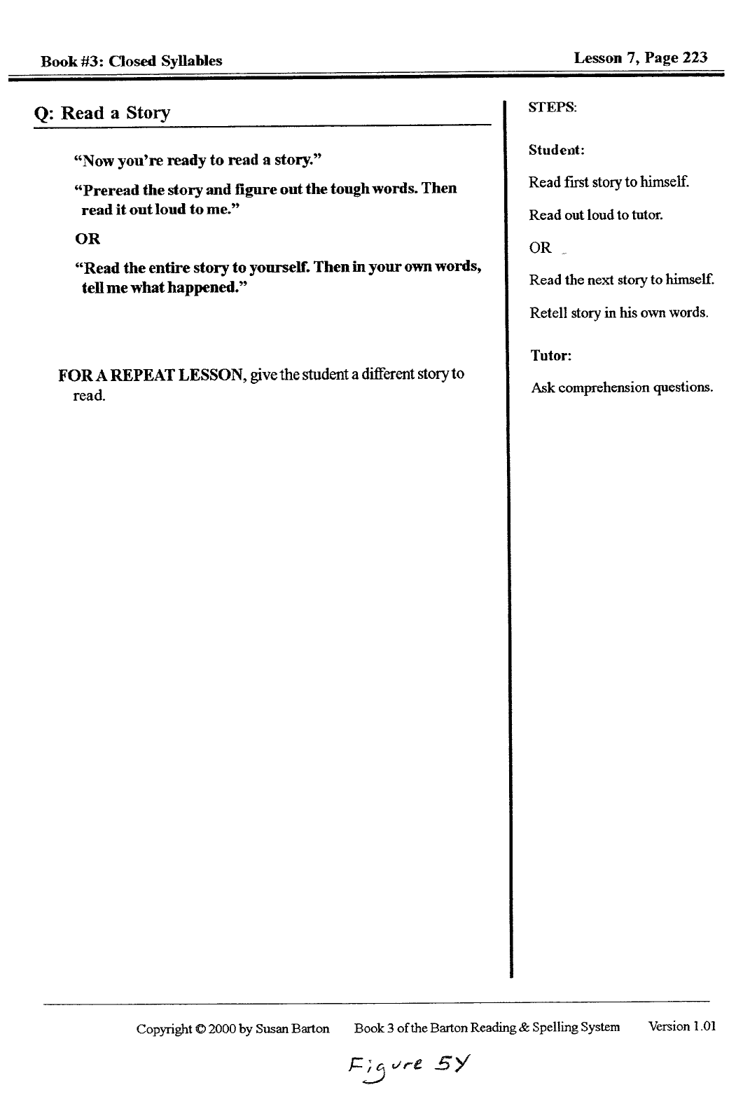

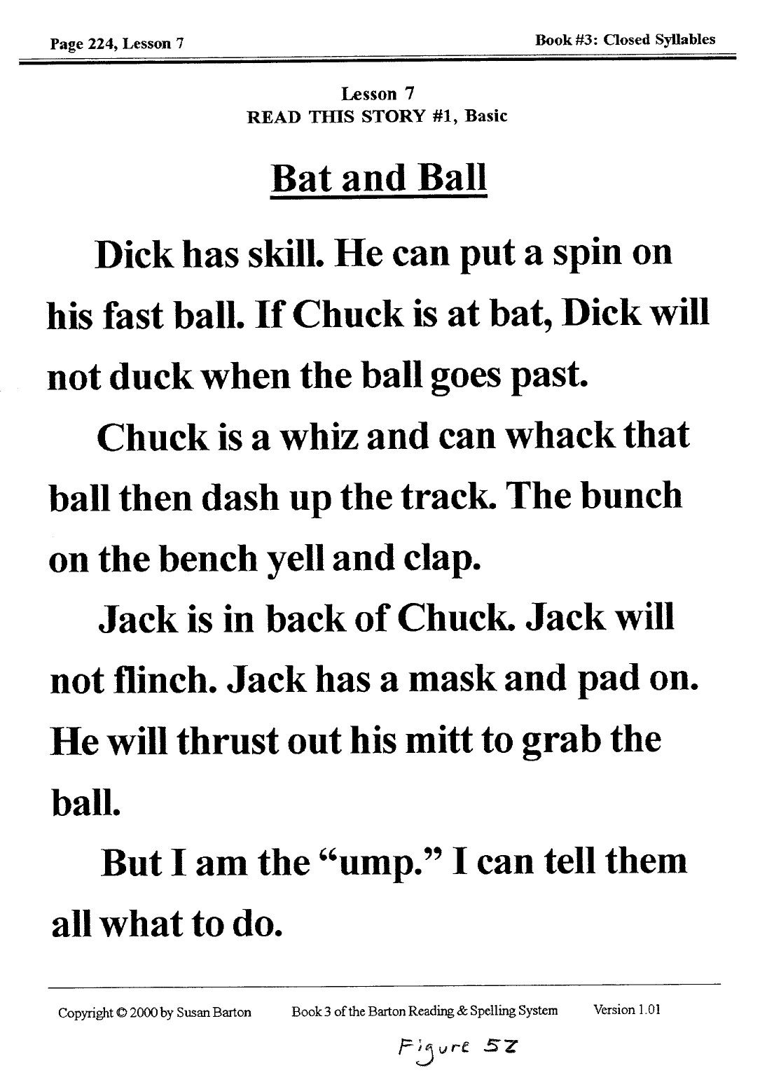

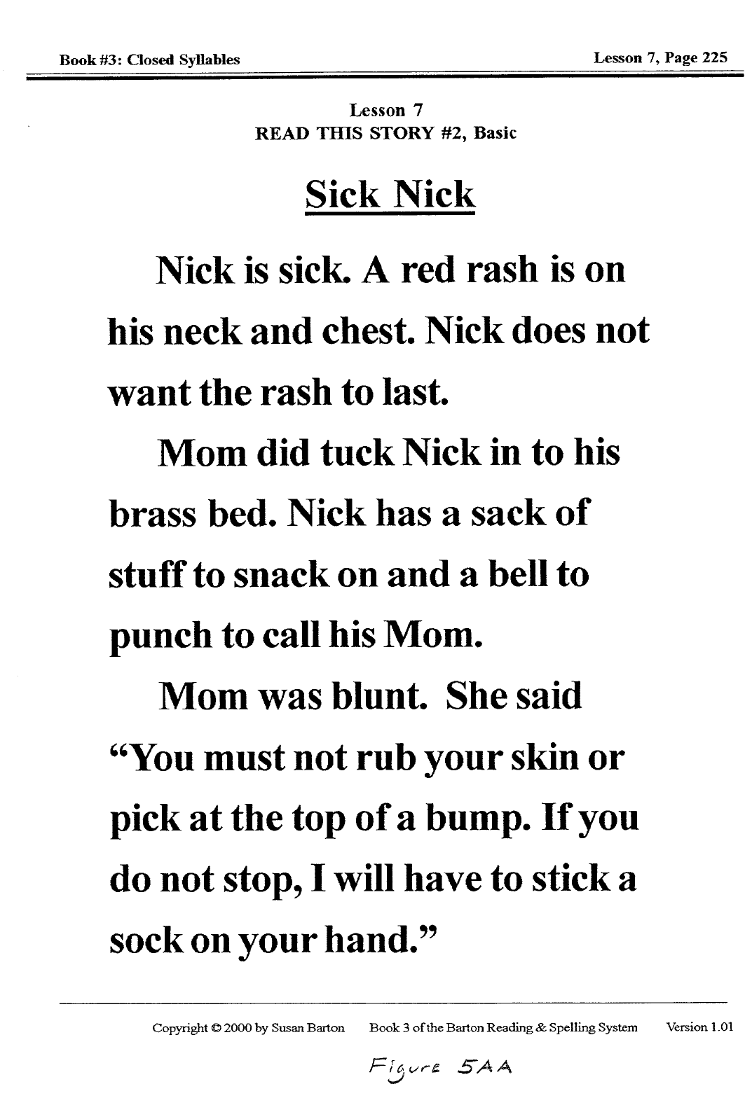

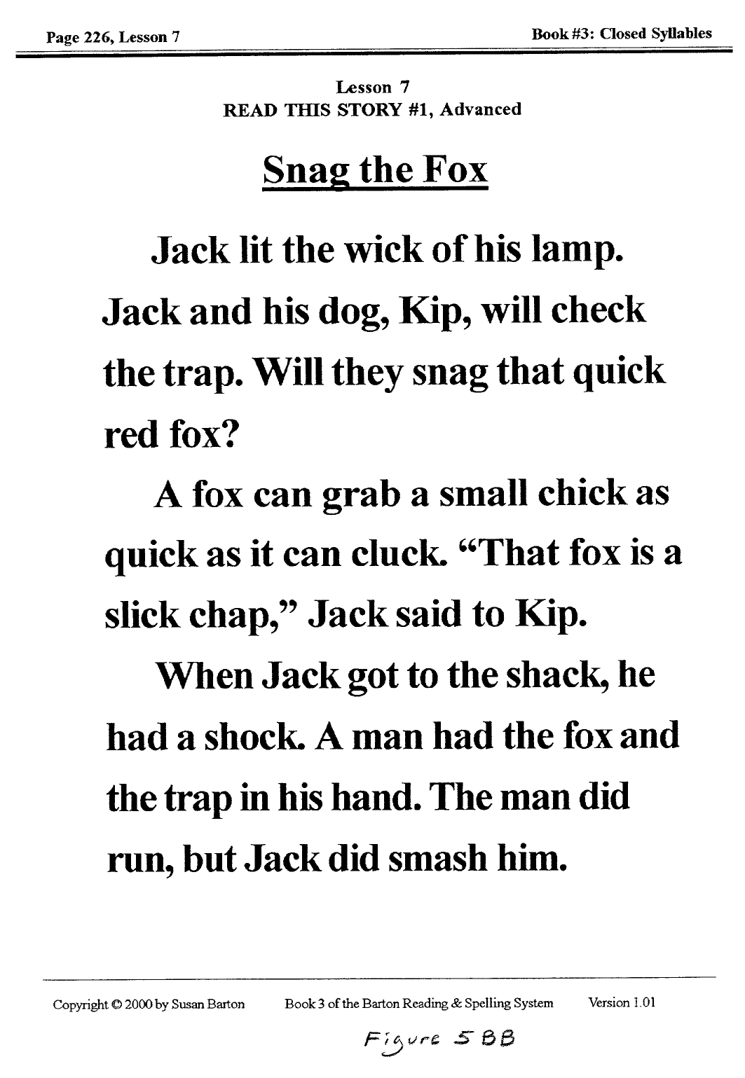

All of the lesson plans for one level are preferably contained in one manual. Typically, as shown in FIG. 5, each page of a lesson has a relatively wide inner column 100, a relatively narrow outer column 102, pictures such as icons 104, and a “FOR A REPEAT LESSON” section 106 at the bottom of the wide column.

Considered in more detail, for tutors who have word-retrieval difficulties, the lesson plans provide full scripting in the wide column 100. Specifically, what they should say to a dyslexic student is inside quotes. Furthermore, bullets indicate actions by the student or tutor. The wide column also contains “TUTOR NOTES” 108.

Each lesson procedure consists of several steps. Tutors with dyslexia have difficulty memorizing steps in a procedure. Consequently, “reminder icons” 104 have been designed and are printed at each important step in the procedure. That way, tutors can simply glance at the icons to see what they are supposed to do. These icons 104 may appear in the wide column 100, as well as at the bottom of the narrow column 102.

The narrow column 102 is for tutors who cannot read rapidly enough to take advantage of the full scripting that appears in the wide column 100. The narrow column 102 contains just the words to build or dictate, along with key questions to ask a dyslexic student. Also provided in each column 100, 102 are small numbers that allow a new tutor who cannot remember what to say to briefly return to the wide column, use the full scripting for a few lines, and then jump back into the narrow column to continue the lesson.

In the lower half of each narrow column 102 is a “Steps” section 110, which summarizes the steps the tutor should perform during the lesson procedure. The “Steps” section 110 displays both icons and two or three words next to each icon to describe each step.

The “FOR A REPEAT LESSON” section 106 appears at the bottom of each wide column. The “FOR A REPEAT LESSON” section 106 contains only the words, phrases, or sentences that a tutor would need if a student is to repeat that lesson.

One aspect of the system of the present invention is the use of unique hand gestures and icons to script the use of those gestures within the lesson plans. By way of background, persons with dyslexia often have attention deficit disorder (“ADD”), as well. Persons with ADD benefit from structure and consistency, yet they relish variety. Unfortunately, if variety is provided by doing many different activities in a lesson, a dyslexic student often becomes confused, because he or she cannot remember the steps in each activity. To solve that problem, tutors using the system of the present invention employ a unique system of hand gestures. The hand gestures remind the student what he or she is to do next. The hand gestures help focus and maintain the attention of the ADD dyslexic student, as his or her eyes will naturally follow whatever is moving. Because it is difficult for a tutor with dyslexia to memorize a series of hand gestures, icons 104 representing those hand gestures appear in the lesson plan manual.

By way of further background, a traditional Orton-Gillingham-based lesson plan has three parts: the visual part (reading); the auditory part (spelling); and the kinesthetic part (writing). A tutor conducts the visual part as one chunk lasting perhaps 20-30 minutes, then the auditory chunk lasting another 20-30 minutes, then the kinesthetic chunk lasting about 10 minutes. It has been found that because reading skills of dyslexic persons are stronger than their spelling skills, they do not object to the visual part of the lesson, but they dread the auditory portion. Consequently, it has been found that a highly integrated multisensory approach is important.

To make the auditory portion less difficult, and to provide significant spelling practice, the system of the present invention changes the order of the steps. Instead of teaching in “chunks,” the system of the present invention continually switches from visual to auditory during a lesson. The system also integrates the kinesthetic component with the visual and auditory steps. The order of the steps comprising each lesson is unique to the system of the present invention.

The lessons comprising the system of the present invention go from the simplest (for example, isolated sounds) up to the most complex (for example, entire stories). As shown in FIG. 6, the following are the phases within a lesson in accordance with the system of the present invention.

The initial phase of each lesson is REVIEW, as indicated by the numeral 201 shown in FIG. 6. There are two steps to implement REVIEW. The first step is visual review of known sounds. Visual review is conducted using letter tiles that provide letters in isolation. The second step of REVIEW is auditory review of known sounds, that is, matching isolated sounds to the appropriate letter tiles.

The second phase of a lesson is WARM-UP, as indicated by the numeral 202 shown in FIG. 6. WARM-UP entails a phonemic awareness warm-up, which involves isolating the first, last, or middle sound in a spoken nonsense word and then matching it to the appropriate letter tile.

The next, or third, phase of a lesson is NEW TEACHING of a concept or rule, as indicated by the numeral 203 shown in FIG. 6. NEW TEACHING may also include teaching a related concept such as an exception to a newly learned rule.

The fourth phase of a lesson is for the dyslexic student to PRACTICE reading and spelling in color using color-coded letter tiles, as indicated by the numeral 204 shown in FIG. 6. First, the dyslexic student practices the new rule or concept visually. The tutor builds real words using color-coded letter tiles that demonstrate the new rule or concept, and the student reads the words. Second is auditory practice by the student of the new rule or concept. The tutor dictates real words, and the student spells the words using the color-coded tiles. Third is visual practice using nonsense words. The tutor builds nonsense words using color-coded tiles, and then the student reads them. The fourth and final step of PRACTICE is auditory practice of the new rule or concept using nonsense words. The tutor dictates nonsense words that the student spells using the color-coded tiles.

The next, or fifth, phase of a lesson involves transference to black and white. As indicated by the numeral 205 shown in FIG. 6, this entails visual practice using real and nonsense printed words (in black and white) presented in ISOLATION in a word frame that will be described in more detail later. The dyslexic student reads the words.

The next, or sixth, phase of a lesson is auditory and kinesthetic practice, as indicated by the numeral 206 shown in FIG. 6. That is, the tutor dictates real and nonsense words. The dyslexic student must WRITE the words on paper, in black and white. While handwriting is difficult for the student, handwriting reinforces the kinesthetic component.

The seventh through tenth phases of a lesson are practice with more words at once. The seventh phase involves visual practice, that is, the dyslexic student READS PHRASES that contain words using the new rule or concept, as well as words using rules previously learned by the student, as indicated by the numeral 207 shown in FIG. 6. This also involves auditory and kinesthetic practice. The next, or eighth, phase of a lesson requires the student to SPELL A PHRASE, writing it onto paper, as indicated by the numeral 208 shown in FIG. 6. This is followed by additional visual practice as the ninth phase of a lesson, because the student READS SENTENCES, as indicated by the numeral 209 shown in FIG. 6. For additional auditory and kinesthetic practice, the student during the tenth phase of a lesson is also required to SPELL A SENTENCE, writing it onto paper, punctuated correctly, as indicated by the numeral 210 shown in FIG. 6.

Many persons with dyslexia have word retrieval deficiencies. With a traditional Orton-Gillingham-based approach, a dyslexic person can be taught to read, but will always be a relatively slow reading person, and will often sound like a robot when he or she reads aloud. Recent NIH research has shown that the only effective way to improve a dyslexic's word retrieval speed is through repeated reading of the same material. Four to five repeated readings appear to provide maximum improvement in reading fluency and reading speed. The challenge is how to prevail on an already reluctant reader to read the same material four to five times.

The system of the present invention solves this problem through the use of phrases and repeated reading of those phrases, as indicated by the numeral 207 shown in FIG. 6. Printed phrases are divided into categories, namely, 1) Who phrases, then Did What phrases, then Where phrases, then Add On phrases.

After a student reads all of the Who and all of the Did What phrases, he or she stops and creates as many sentences as he or she can from those two categories, pointing to each phrase when incorporated into the sentence. Then, the student reads the Where phrases. He or she then stops and creates three or four more sentences while pointing to the phrases. Next, the student reads the Add On phrases and then creates two to three more sentences while pointing to the phrases.

Experience in using the system of the present invention demonstrates that dyslexic students enjoy creating real and “funny” sentences out of these phrases. They do not even realize they have just read the same phrase at least four to five times and are improving their reading fluency.

This technique is carried over into the reading of sentences, as indicated by the numeral 209 shown in FIG. 6. A student reads each sentence at least four times. But each time a student reads the sentence, he or she is performing a different task and therefore does not resist.

First, the dyslexic student reads the sentence to himself or herself to figure out the “tough” words. Then, the student reads the sentence aloud. Next, the student marks the phrases in the sentence. In the process, he or she must read the sentence again to find and mark the phrases. The student then reads the sentence aloud with good phrasing. As a consequence, through these various tasks, the student has now read the sentence at least four times. In contrast to known Orton-Gillingham-based systems, the system of the present invention emphasizes phrasing, and is the only system that incorporates repeated readings as a way to improve reading fluency and reading speed.

As shown in FIG. 6, this is followed by even more visual practice. The next, or eleventh, phase of a lesson requires the dyslexic student to READ AN ENTIRE STORY and either retell it in his or her own words or answer comprehension questions, as indicated by the numeral 211 shown in FIG. 6. The final, or twelfth, phase of a lesson requires the student to COMPLETE HOMEWORK PAGES, as indicated by the numeral 212 shown in FIG. 6. In contrast to traditional Orton-Gillingham-based systems, the lesson plans provided by the system of the present invention constantly juxtapose visual practice with auditory practice.

Additionally, the system of the present invention is a multi-entry-point system. In other words, each dyslexic student can enter the system at a different point. In contrast, known Orton-Gillingham-based systems insist that no matter what the dyslexic student already knows, he or she must start back at the beginning and go step by step through the system. However, adult literacy programs desire a system that gives the student credit for what he or she has already mastered, and allow him or her to start working on new material.

In the system of the present invention, to determine where to start a dyslexic student, a tutor can give the student a post test provided with each level (Levels 1-10). If the student completes all portions of a post test with substantially 100% accuracy, the tutor administers the post test from the next higher level to the student, and so on. If the student has difficulty on the post test, the tutor circles the item, and the lesson number in which that skill is taught. The tutor then starts the student on the lowest circled lesson. As indicated above, the lesson plans contain sufficient scripting that even a new tutor can competently start teaching at any point within a level.

As mentioned earlier, the system of the present invention provides spelling rule pages in the lesson plans. Exemplary spelling rule pages are shown in FIGS. 5H, 5J, and 5N. Only a limited number of spelling rules are taught by known Orton-Gillingham-based systems. The system in accordance with the present invention teaches four times as many spelling rules as traditional Orton-Gillingham-based systems. That is, 25% of the spelling rules are taught by known Orton-Gillingham-based systems, and 75% of the spelling rules that are taught are unique to the system of the present invention. Preferably, names are accorded to each of the myriad spelling rules to aid recall of the associated rule by the dyslexic student, for example, the “Milk Truck” rule, as shown in FIG. 5A.

Referring again to FIG. 2, the system of the present invention also comprises colored tiles, including color-coded letter tiles. Known Orton-Gillingham-based systems use flashcards. They employ one color for consonants and a different color for vowels.

Persons with dyslexia have a very difficult time memorizing. Dyslexic children dislike flashcards, and adults often find them offensive. Teachers have attempted to instruct by presenting almost everything on flashcards. They, too, dislike flashcards.

Tiles help focus dyslexic students not only on sounds, but as they advance, on units of meaning. The tiles comprising the system of the present invention are not simply two colors, but at least six colors. Tiles enable kinesthetic participation by the student and provide tactile feedback. Tiles occupy less area than flashcards, and they slide smoothly and quietly on a surface such as a tabletop or the top of a desk.

Considered in more detail, the tiles provided by the system of the present invention are the “manipulatives” to implement a multisensory system of teaching dyslexic persons to read and spell. Some tiles have no letter. These are used to teach the concept of phonemes before letters are introduced. A “phoneme” is a single, indivisible sound in spoken language, as originally identified by Orton and Gillingham.

The system of the present invention also comprises tiles having one or more letters. Each lettered tile typically represents a phoneme. The dyslexic student is taught to hear sounds and manipulates the tiles to assemble the sounds into words. This manipulation is a primary part of the student's association of individual phonemes with the syllables or words that the phonemes form.

Preferably, the tiles are color-coded using primary colors. For example, in one preferred embodiment, tiles having consonants are one color (blue), vowels another (yellow), units of sound another (red), and so on.

Some tiles have single letters, vowels or consonants, for example. Other tiles have two or more letters that form single sounds, for example, SH, CH, WH, TH, PH, CK, TCH, DGE. Advanced lessons of the system include tiles with as many as four letters that represent special sounds, blends of sounds, prefixes, suffixes, and Latin roots.

The tiles for each class of phonemic object, such as a vowel, consonant, digraph, trigraph or unit, have background colors that represent the class. Therefore, a dyslexic student can instantly recognize the type of phoneme that a tile represents by its color. One preferred embodiment of the system of the present invention comprises a total of 202 tiles, although any particular lesson uses a smaller subset of the tiles. In the preferred embodiment, the tile colors are as follows:

blue: consonants, digraphs, and trigraphs

yellow: vowels and vowel teams

red: units of unusual sound combinations (for example, TION, SURE)

orange: prefixes

green: suffixes

white: Latin roots

Occasionally, the same letter or group of letters can form more than one type of sound. The letter Y, for example, can be a consonant or a vowel. In such cases, the system of the present invention includes the same letter or group in more than one color, for example, blue consonant-Y tiles and yellow vowel-Y tiles.

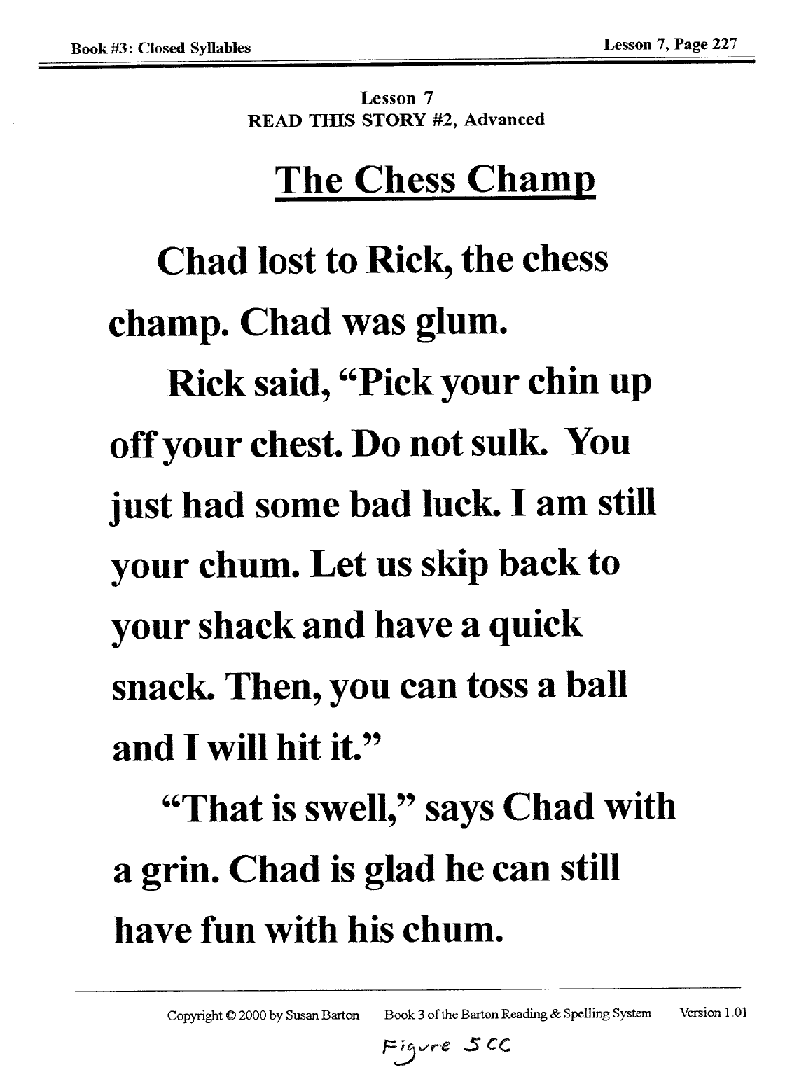

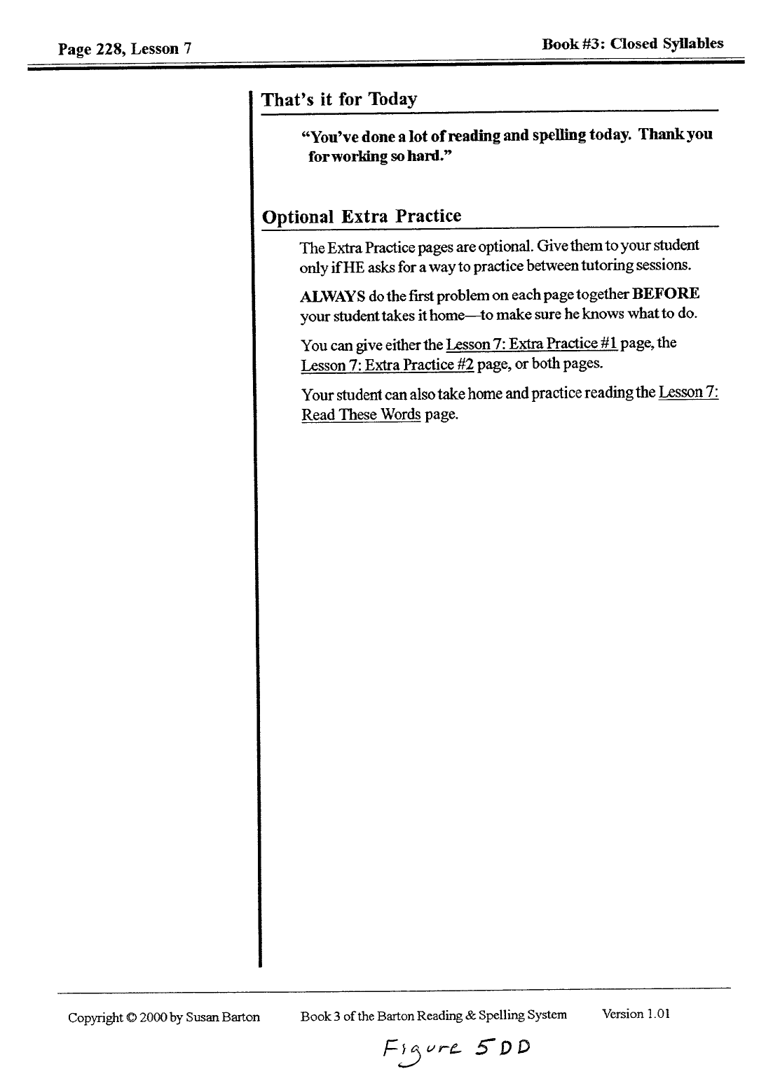

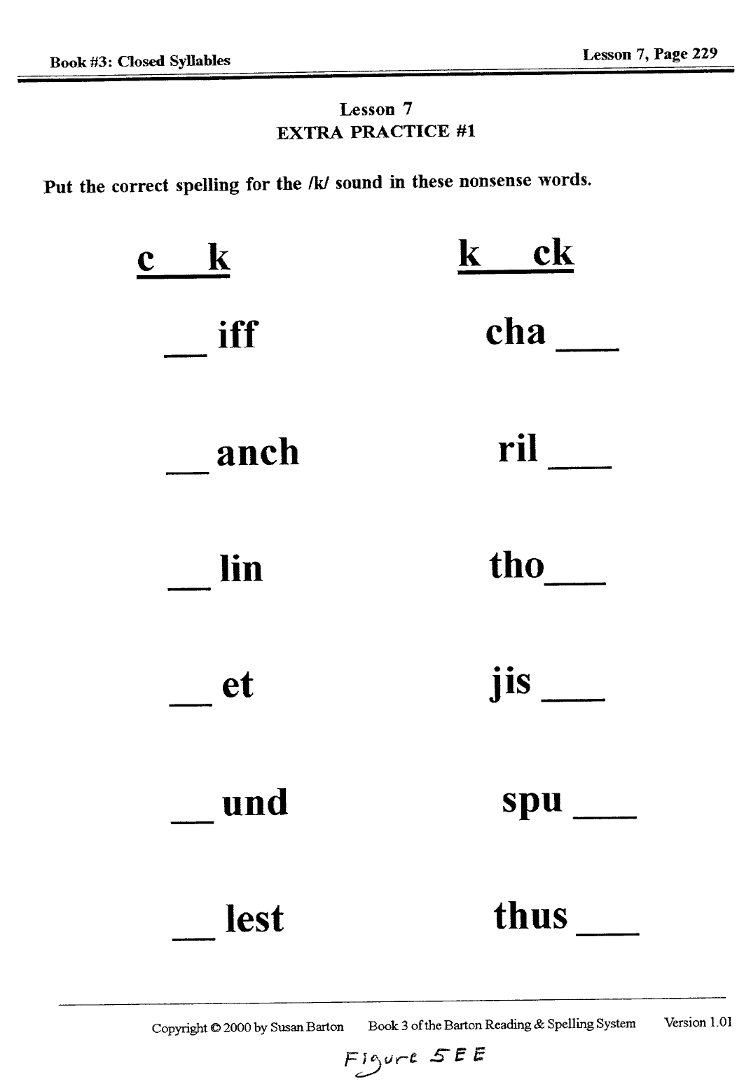

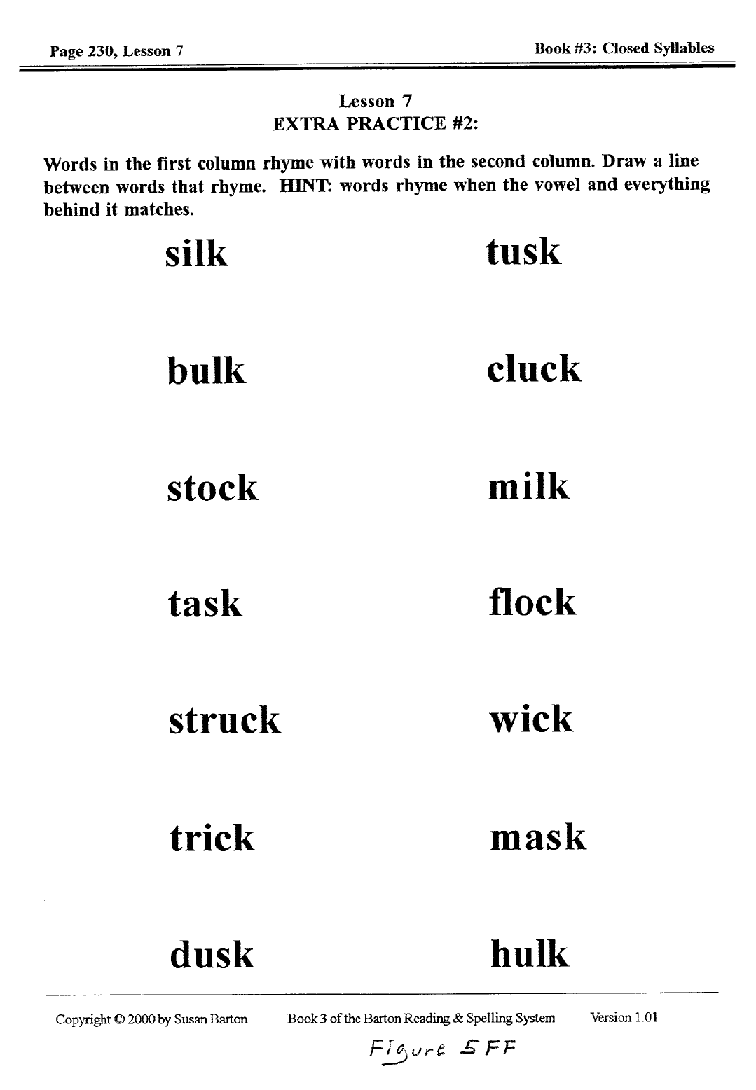

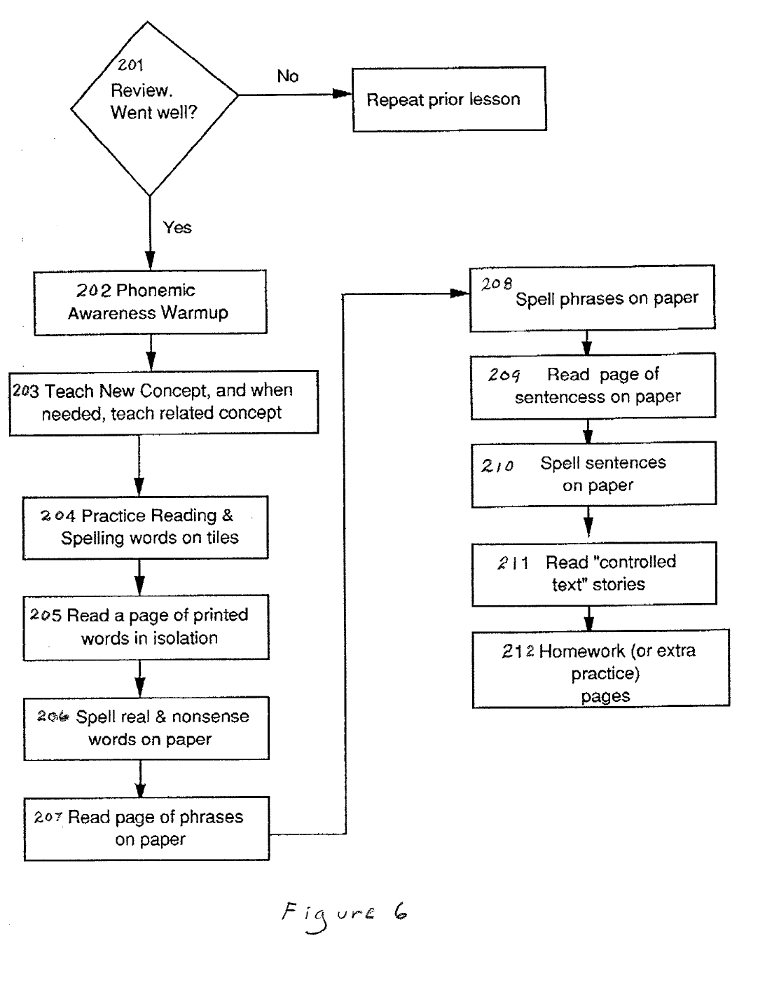

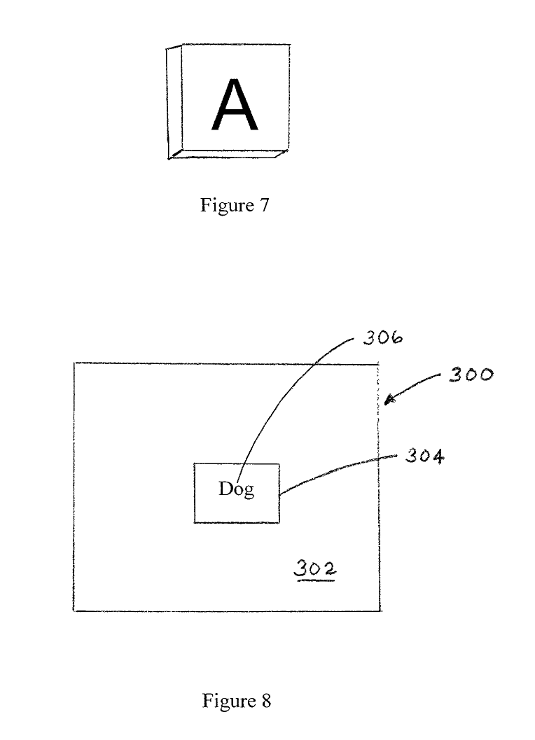

As shown in FIG. 7, in one implementation of the system of the present invention, each color-coded tile is approximately one inch square and ¼-inch thick. A letter or group of letters is preferably printed in a contrasting color such as black on one surface in a large font size, for example, Arial 44-pt. The preferred material from which the tiles are constructed is painted wood, because wooden tiles are lightweight, and they slide easily and quietly over a tabletop or desk surface.

Dyslexic students are most confused about vowels, since vowels make so many different sounds. To clarify the roles of vowels, and how their sounds can be precisely determined, the system of the present invention teaches that the English language comprises six types of syllables, all based on the number and location of the vowels within the syllables. Dyslexics learn to identify syllable type. Once they can identify the type, they know what sound the vowel must make. To help the student focus on the vowels, vowel tiles are preferably bright yellow.

Adding consonant tiles, which are preferably blue, the dyslexic student learns to “blend” the consonant and vowel sounds together, first to form small words, then syllables of longer words. By learning rules that allow “sounding out” words, rather than attempting to memorize the overall shapes of words, the student will later be able to increase his or her vocabulary without limit. Some call this fundamental capability “word attack skill.”

In the English language, certain combinations of three or four letters make unique sounds that are not the same as the sound one would obtain by the sounding-out rules. The system in accordance with the present invention denominates these letter groups “units.” Examples include ING, TION, TURE. “Units” typically appear at the end of words. Because they cannot be sounded out, the student must memorize them. The system of the present invention preferably represents unit syllables using red tiles.

Dyslexic students also use the tiles when spelling. First, they break a word into its individual sounds. Then they build the word, tile by tile, with each tile representing one of the sounds in the word. They must also check the placement of each vowel tile to assure it can make the required sound in the position in which they place it.

Once a dyslexic student can use the tiles to read and spell one-syllable words containing up to six sounds, he or she moves and manipulates the tiles to learn the syllable-division rules. The tiles are an important part of the process, in which the student moves the tiles to identify and represent parts of words, split letters into their different syllables, and even experiment with sounds represented by the tiles.

Dyslexics lack an innate understanding of word morphology, that is, how word segments work together. To help them practice applying this concept, the system of the present invention includes orange tiles with prefixes, green tiles with suffixes, and white tiles with Latin roots. For example, the tiles play an important role when teaching spelling rules associated with suffixes, for example, changing a final Y to an I before adding a suffix.

As mentioned above, the system of the present invention also preferably comprises a word frame 300, as shown in FIG. 9. Traditionally, to force a dyslexic student to examine a word and not use context clues to help him or her guess what the word is, known Orton-Gillingham-based systems must present words in isolation. These Orton-Gillingham-based systems accomplish this with flashcards. Tutors must either make their own flashcards using blank index cards, or buy them from the publisher of the system. It has been found that many volunteer tutors do not take the time to create word flashcards, or experience frustration trying to organize the cards.

As shown in FIG. 9, the system of the present invention provides the word frame 300 as an easier way to present words in isolation. The word frame 300 is preferably constructed from a plain, pastel colored, 5×8-inch index card 302 with a rectangular hole 304. Printed words are widely separated on an 8½×11 sheet of paper. The tutor overlays the hole 304 in the word frame 300 to display only one word 306 at a time. This eliminates the need for word flashcards. The word frame 300 of the system of the present invention is unique among Orton-Gillingham-based systems.

Although the present invention has been described with a particular degree of specificity with reference to various embodiments, it should be understood that numerous changes both in the form and steps disclosed can be made without departing from the spirit of the invention. For example, lesson plans can incorporate optional games to reinforce newly taught skills. Also, while the tutor training has been described to comprise videotape, any video medium such as a DVD can be used to provide tutor training. Additionally, the tiles of the system of the present invention could be used with other Orton-Gillingham-based systems. Furthermore, other color-coded tiles could be employed to teach other words. For example, tiles having Greek words could be color-coded lavender. While wooden tiles have been described, the tiles can be constructed from other material such as plastic. Also, the tiles can be replaced by magnetic or Velcro-backed objects or any other configuration of manipulative object, colored to correspond to classes of sounds in an alphabetic language, and having letters printed on them to represent particular sounds, so that the objects can be used in teaching reading and spelling of the alphabetic language. Preferably, the system of the present invention also includes separate student pages. A home school parent might have several children who need tutoring, yet the dyslexic student must write on many of the lesson plan pages. Also, if a tutor sits across from a student, but there is only one copy of the reading material, the tutor must learn to read upside down, which may be difficult for first-time tutors. Consequently, the system preferably provides a separate set of “student pages”. Each page that a student must read from or write on is included in the student pages. Tutors who plan to work with more than one student are encouraged to xerographically reproduce a set of those pages for each student. As a result, the student does not mark up the tutor's manual, and the tutor can view his or her own copy of the reading material that is in the lesson plan manual “right side up”, while the student across from him or her reads from the student copy. The scope of protection sought is to be limited only by the scope of the appended claims that are intended to suitably cover the invention.

I claim:

1. A method for instructing a dyslexic person to read and spell, the method comprising the steps of:
teaching phonemic awareness to a dyslexic student;
teaching the student simple sound-symbol relationships with only short vowels in three-sound, consonant-vowel-consonant words;
improving sound-symbol relationships using longer words having up to six sounds in a one-syllable word with only one short vowel and teaching associated spelling rules, and teaching the student two types of syllables, namely, closed and unit;
teaching the student two additional types of syllables, namely, an open syllable and a vowel team, two initial syllable-division rules, accents and schwas and associated spelling rules, the last two syllable-division rules, spelling rules that apply to words with three or more syllables, and the most common vowel teams and how to use the syllable-division rules with vowel teams;
teaching the student the meaning of the most common suffixes and associated spelling rules, followed by the most common prefixes, and silent-E words having suffixes;
teaching the student reasons for a silent-E and two more types of syllables, namely, silent-E and consonant-LE;
teaching the student how a vowel-R affects the sound of vowels and associated spelling rules;
teaching the student advanced vowel teams, most of which can form more than one sound, and associated spelling rules;
teaching the student reading and spelling rules pertaining to words borrowed from French, along with some common Greek spellings; and
teaching the student comprehension of long, high school and college level words, most of which derive from Latin or Greek, the meaning of common Latin roots, as well as how to combine the roots with previously learned prefixes and suffixes, and the meaning of more esoteric Latin prefixes and associated spelling rules.

2. The method of claim 1 wherein the step of teaching phonemic awareness comprises teaching all seven essential phonemic awareness skills before letters are introduced, the seven skills consisting of: 1) counting sounds; 2) segmenting sounds; 3) deleting sounds; 4) comparing sounds; 5) replacing sounds; 6) blending sounds; and 7) rhyming.

3. The method of claim 2 wherein three procedures are directly and explicitly employed to teach six of the seven phonemic awareness skills, the procedures consisting of: 1) break; 2) break-replace-remove; and 3) compare.

4. In an Orton-Gillingham-based method for instructing a dyslexic person to read and spell, the improvement comprising the step of:
teaching phonemic awareness to a dyslexic student prior to teaching visual reading skills.

5. The method of claim 4, further comprising the steps of:
teaching the student reading and spelling rules pertaining to words borrowed from French, along with some common Greek spellings; and
teaching the student comprehension of long, high school and college level words, most of which derive from Latin or Greek, the meaning of common Latin roots, as well as how to combine the roots with previously learned prefixes and suffixes, and the meaning of more esoteric Latin prefixes and associated spelling rules.

6. A system for instructing a dyslexic student to read and spell, comprising:
written materials that provide fully scripted lesson plans; and
manipulative objects that correspond to phonemes in an alphabetic language to aid dyslexic students to learn to read and spell by making use of the student's kinesthetic memory;
whereby the objects can be moved about a supporting surface to form sounds or whole words.

7. The system of claim 6 wherein the manipulative objects comprise tiles that correspond to phonemes in the alphabetic language.

8. The system of claim 7 wherein the tiles comprise a tile set that has a total of 202 tiles of six different types.

9. The system of claim 7 wherein the tiles have one of a plurality of background colors and the tile background colors correspond to the type of sound, or class of language element, they represent.

10. The system of claim 9 wherein the tiles have one or more letters printed on a surface to represent particular phonemes for use in teaching reading and spelling of the alphabetic language and the tiles representing vowels, vowel teams, or vowel-R's are yellow, tiles representing consonants or consonant digraphs or trigraphs are blue, tiles representing units are red, tiles representing prefixes are orange, tiles representing suffixes are green, and tiles representing Latin roots are white.

11. The system of claim 7 wherein the tiles are constructed of wood and are approximately 1×1×¼-inch, colored to correspond to types of sounds, and have one or more letters printed on a surface to represent particular phonemes for use in teaching reading and spelling of the alphabetic language.

12. The system of claim 7 wherein the tiles form a set of tiles having colors and letters corresponding to an Orton-Gillingham set of phonetic sounds of the American English language.

13. The system of claim 6, further comprising an electronic spell checker.

14. The system of claim 13 wherein the electronic spell checker enables words to be looked up phonetically.

15. The system of claim 6, further comprising video to instruct a tutor to teach the student.

16. The system of claim 15 wherein one or more labels are positioned along the left side and across the bottom of video images to inform the viewer what is being taught or demonstrated

17. The system of claim 6, further comprising a word frame to present words in isolation.

18. The system of claim 17 wherein the word frame is constructed from a plain, pastel colored, 5×8-inch index card with a rectangular hole.

19. The system of claim 6, wherein the lesson plans comprise: 1) a review of material taught in the last lesson; 2) a phonemic awareness warm-up exercise; 3) a fully scripted “Teaching A New Concept” section; 4) lists of real and nonsense reading and spelling words to practice the new concept using tiles; 5) a page of printed words in isolation for reading practice; 6) a list of real and nonsense spelling words to write on paper; 7) a page of phrases for reading practice; 8) six phrases for spelling practice; 9) a page of sentences for reading practice; 10) six sentences for spelling practice; 11) four “controlled text” stories (two for children and two for adults); and 12) two homework (or extra practice) pages.

20. The system of claim 19 wherein the lesson plans further comprise a “FOR A REPEAT LESSON” section so a tutor can conduct a lesson twice without having to re-use the same words, phrases, or sentences.
